(19) United States
(12) Patent Application Publication
(10) Pub. No.: US 2013/0194386 A1
(43) Pub. Date: Aug. 1, 2013

(54) Joint Layer Optimization for a Frame-Compatible Video Delivery

(71) Applicants: Athanasios Leontaris, Mountain View, CA (US); Alexandros Tourapis, Milpitas, CA (US); Peshala V. Pahalawatta, Glendale, CA (US)

(72) Inventors: Athanasios Leontaris, Mountain View, CA (US); Alexandros Tourapis, Milpitas, CA (US); Peshala V. Pahalawatta, Glendale, CA (US)

(73) Assignee: Dolby Laboratories Licensing Corporation, San Francisco, CA (US)

(21) Appl. No.: 13/878,558

(22) PCT Filed: Sep. 20, 2011
(86) PCT No.: PCT/US11/52306

§ 371 Date: Apr. 9, 2013

Related U.S. Application Data
(60) Provisional application No. 61/392,458, filed on Oct. 12, 2010.

(51) Int. Cl. H04N 13/00

(52) U.S. Cl. CPC H04N 13/0048
USPC 348/43

(57) ABSTRACT

Joint layer optimization for a frame-compatible video delivery is described. More specifically, methods for efficient mode decision, motion estimation, and generic encoding parameter selection in multiple-layer codecs that adopt a reference processing unit (RPU) to exploit inter-layer correlation to improve coding efficiency as described.

### CROSS-REFERENCE TO RELATED APPLICATIONS

This application claims priority to U.S. Provisional Patent Application No. 61/392,458 filed 12 Oct. 2010. The present application may be related to U.S. Provisional Application No. 61/365,743, filed on Jul. 19, 2010, U.S. Provisional Application No. 61/223,027, filed on Jul. 4, 2009, and U.S. Provisional Application No. 61/170,995, filed on Apr. 20, 2009, all of which are incorporated herein by reference in their entirety.

### TECHNOLOGY

The present invention relates to image or video optimization. More particularly, an embodiment of the present invention relates to joint layer optimization for a frame-compatible video delivery.

### BACKGROUND

Recently, there has been considerable interest and traction in the industry towards stereoscopic (3D) video delivery. High grossing movies presented in 3D have brought 3D stereoscopic video into the mainstream, while major sports events are currently also being produced and broadcast in 3D. Animated movies, in particular, are increasingly being generated and rendered in stereoscopic format. While there is already a sufficiently large base of 3D-capable cinema screens, the same is not true for consumer 3D applications. Efforts in this space are still in their infancy, but several industry parties are investing considerable effort into the development and marketing of consumer 3D-capable displays (see reference [1]).

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a horizontal sampling/side by side arrangement for the delivery of stereoscopic material.

FIG. 2 shows a vertical sampling/over-under arrangement for the delivery of stereoscopic material.

FIG. 3 shows a scalable video coding system with a reference processing unit for inter-layer prediction.

FIG. 4 shows a frame-compatible 3D stereoscopic scalable video encoding system with reference processing for inter-layer prediction.

FIG. 5 shows a frame-compatible 3D stereoscopic scalable video decoding system with reference processing for inter-layer prediction.

FIG. 6 shows a rate-distortion optimization framework for coding decision.

FIG. 7 shows fast calculation of distortion for coding decision.

FIG. 8 shows enhancements for rate-distortion optimization in a multi-layer frame-compatible full-resolution video delivery system. Additional estimates of the distortion in the enhancement layer (EL) are calculated (D′ and D″). An additional estimate of the rate usage in the EL is calculated (R′).

FIG. 9 shows fast calculation of distortion for coding decision that considers the impact on the enhancement layer.

FIG. 10 shows a flowchart illustrating a multi-stage coding decision process.

FIG. 11 shows enhancements for rate-distortion optimization in a multi-layer frame-compatible full-resolution video delivery system. The base layer (BL) RPU uses parameters that are estimated by an RPU optimization module that uses the original BL and EL input. Alternatively, the BL input may pass through a module that simulates the coding process and adds coding artifacts.

FIG. 12 shows fast calculation of distortion for coding decision that considers the impact on the enhancement layer and also performs RPU parameter optimization using either the original input pictures or slightly modified inputs to simulate coding artifacts.

FIG. 13 shows enhancements for rate-distortion optimization in a multi-layer frame-compatible full-resolution video delivery system. The impact of the coding decision on the enhancement layer is measured by taking into account motion estimation and compensation in the EL.

FIG. 14 shows steps in an RPU parameter optimization process in one embodiment of a local approach.

FIG. 15 shows steps in an RPU parameter optimization process in another embodiment of the local approach.

FIG. 16 shows steps in an RPU parameter optimization process in a frame-level approach.

FIG. 17 shows fast calculation of distortion for coding decision that considers the impact on the enhancement layer. An additional motion estimation step considers the impact of the motion estimation in the EL as well.

FIG. 18 shows a first embodiment of a process for improving motion compensation consideration for dependent layers that allows use of non-causal information.

FIG. 19 shows a second embodiment of a process for improving motion compensation consideration that performs coding for both previous and dependent layers.

FIG. 20 shows a third embodiment of a process for improving motion compensation consideration for dependent layers that performs optimized coding decisions for the previous layer and considers non-causal information.

FIG. 21 shows a module that takes as input the output of the BL and EL and produces full-resolution reconstructions of each view.

FIG. 22 shows fast calculation of distortion for coding decision that considers the impact on the full-resolution reconstruction using the samples of the EL and BL.

FIG. 23 shows fast calculation of distortion for coding decision that considers distortion information and samples from a previous layer.

### DESCRIPTION OF EXAMPLE EMBODIMENTS

According to a first embodiment of the present disclosure, a method for optimizing coding decisions in a multi-layer layer frame-compatible image or video delivery system is provided, comprising one or more independent layers, and one or more dependent layers, the system providing a frame-compatible representation of multiple data constructions, the system further comprising at least one reference processing unit (RPU) between a first layer and at least one of the one or more dependent layers, the first layer being an independent layer or a dependent layer, the method comprising: providing a first layer estimated distortion; and providing one or more dependent layer estimated distortions.

According to a second embodiment of the present disclosure, a joint layer frame-compatible coding decision optimization system is provided, comprising: a first layer; a first layer estimated distortion unit; one or more dependent layers; at least one reference processing unit (RPU) between the first layer and at least one of the one or more dependent layers; and one or more dependent layer estimate distortion units between the first layer and at least one of the one or more dependent layers.

While stereoscopic display technology and stereoscopic content creation are issues that have to be properly addressed to ensure sufficiently high quality of experience, the delivery of 3D content is equally critical. Content delivery comprises several components. One particularly important aspect is that of compression, which forms the scope of this disclosure. Stereoscopic delivery is challenging due in part to the doubling of the amount of information that has to be communicated. Furthermore, the computational and memory throughput requirements for decoding such content increase considerably as well.

In general, there are two main distribution channels through which stereoscopic content can be delivered to the consumer: fixed media, such as Blu-Ray discs; and digital distribution networks such as cable and satellite broadcast as well as the Internet, which comprises downloads and streaming solutions where the content is delivered to various devices such as set-top boxes, PCs, displays with appropriate video decoder devices, as well as other platforms such as gaming devices and mobile devices. The majority of the currently deployed Blu-Ray players and set-top boxes support primarily codecs such as those based on the profiles of Annex A of the ITU-T Rec. H.264/ISO/IEC 14496-10 (see reference [2]) state-of-the-art video coding standard (also known as the Advanced Video Coding standard—AVC) and the SMPTE VC-1 standard (see reference [3]).

The most common way to deliver stereoscopic content is to deliver information for two views, generally a left and a right view. One way to deliver these two views is to encode them as separate video sequences, a process also known as simulcast. There are, however, multiple drawbacks with such an approach. For instance, compression efficiency suffers and a substantial increase in bandwidth is used to maintain an acceptable level of quality, since the left and right view sequences cannot exploit inter-view correlation. However, one could jointly optimize their encoding process while still producing independently decodable bitstreams, one for each view. Still, there is a need to improve compression efficiency for stereoscopic video while at the same time maintaining backwards compatibility. Compatibility can be accomplished with codecs that support multiple layers.

Multi-layer or scalable bitstreams are composed of multiple layers that are characterized by pre-defined dependency relationships. One or more of those layers are called base layers (BL), which need to be decoded prior to any other layer and are independently decodable among themselves. The remaining layers are commonly known as enhancement layers (EL) since their function is to improve the content (resolution or quality/fidelity) or enhance the content (addition of features such as adding new views) as provided when just the base layer or layers are parsed and decoded. The enhancement layers are also known as dependent layers in that they all depend on the base layers.

In some cases, one or more of the enhancement layers may be dependent on the decoding of other higher priority enhancement layers, since the enhancement layers may adopt inter-layer prediction either from one of the base layers or one of previously coded (higher priority) enhancement layers. Thus, decoding may also be terminated at one of the intermediate layers. Multi-layer or scalable bitstreams enable scalability in terms of quality/signal-to-noise ratio (SNR), spatial resolution and/or temporal resolution, and/or availability of additional views.

For example, using codecs based on Annex A profiles of H.264/MPEG-4 Part 10, or using the VC-1 or VP8 codecs, one may produce bitstreams that are temporally scalable. A first base layer, if decoded, may provide a version of the image sequence at 15 frames per second (fps), while a second enhancement layer, if decoded, can provide, in conjunction with the already decoded base layer, the same image sequence at 30 fps. SNR scalability, further extensions of temporal scalability, and spatial scalability are possible, for example, when adopting Annex G of the H.264/MPEG-4 Part 10 AVC video coding standard. In such a case, the base layer generates a first quality or resolution version of the image sequence, while the enhancement layer or layers may provide additional improvements in terms of visual quality or resolution. Similarly, the base layer may provide a low resolution version of the image sequence. The resolution may be improved by decoding additional enhancement layers. However, scalable or multi-layer bitstreams are also useful for providing multi-view scalability.

The Stereo High Profile of the Multi View Coding (MVC) extension (Annex H) of H.264/AVC was recently finalized and has been adopted as the video codec for the next generation of Blu-Ray discs (Blu-Ray 3D) that feature stereoscopic content. This coding approach attempts to address, to some extent, the high bit rate requirements of stereoscopic video streams. The Stereo High Profile utilizes a base layer that is compliant with the High Profile of Annex A of H.264/AVC and which compresses one of the views that is termed the base view. An enhancement layer then compresses the other view, which is termed the dependent view. While the base layer is on its own a valid H.264/AVC bitstream, and is independently decodable from the enhancement layer, the same may not be, and usually it is not, true for the enhancement layer. This is due to the fact that the enhancement layer can utilize as motion-compensated prediction references decoded pictures from the base layer. As a result, the dependent view (enhancement layer) may benefit from inter-view prediction. For instance, compression may improve considerably for scenes with high inter-view correlation (low stereo disparity). Hence, the MVC extension approach attempts to tackle the problem of increased bandwidth by exploiting stereoscopic disparity.

However, it does so at the cost of compatibility with the existing deployed set-top box and Blu-Ray player infrastructure. Even though an existing H.264 decoder may be able to decode and display the base view, it will simply discard and ignore the dependent view. As a result, existing decoders will only be able to view 2D content. Hence, while MVC retains 2D compatibility, there is no consideration for the delivery of 3D content in legacy devices. The lack of backwards compatibility is an additional barrier towards rapid adoption of consumer 3D stereoscopic video.

The deployment of consumer 3D can be sped up by exploiting the installed base of set-top boxes, Blu-Ray players, and high definition TV sets. Most display manufacturers are currently offering high definition TV sets that support 3D stereoscopic display. These include major display technologies such as LCD, plasma, and DLP (reference [1]). The key is to provide the display with content that contains both views but still fits within the confines of a single frame, while still utilizing existing and deployed codecs such as VC-1 and H.264/AVC. Such an approach that formats the stereo content so that it fits within a single picture or frame is called frame-compatible. Note that the size of the frame-compatible representation needs not be the same with that of the original view frames.

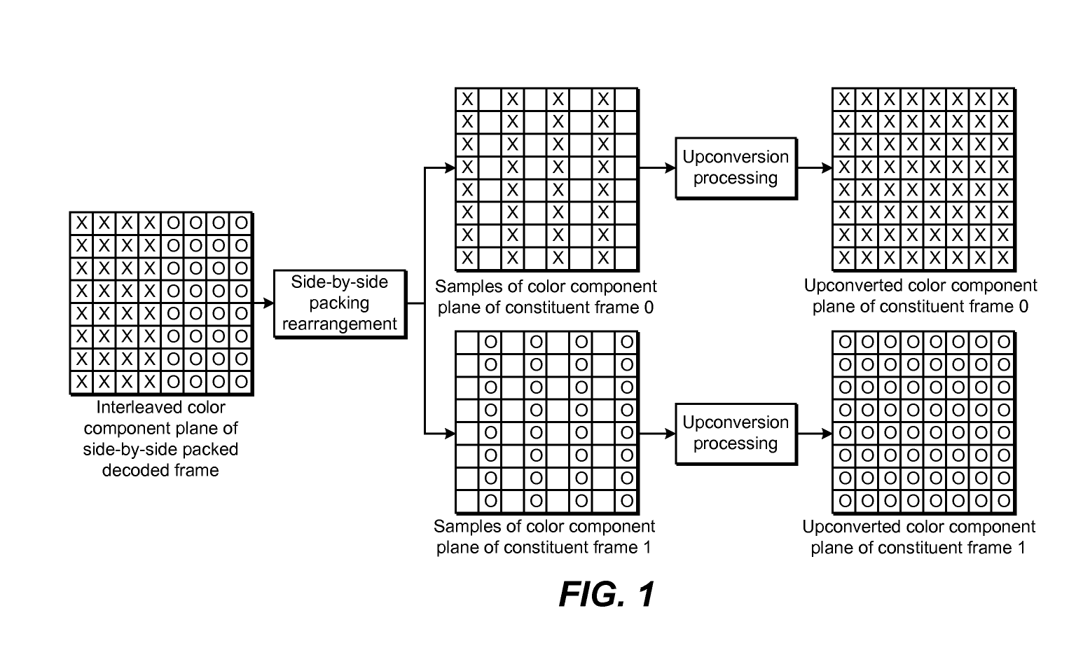

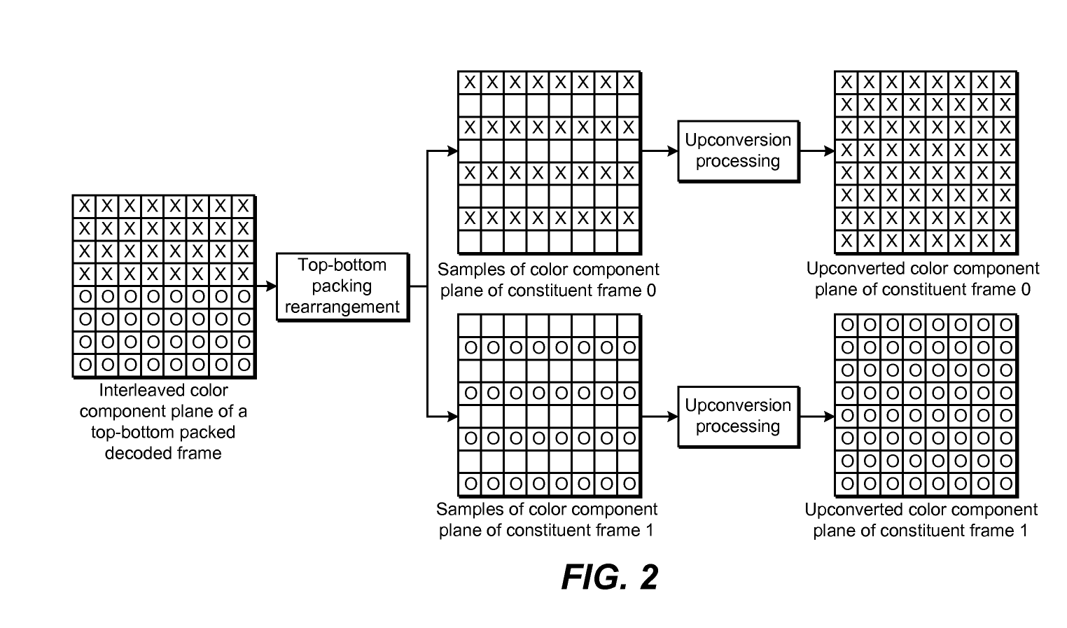

Similarly to the MVC extension of H.264, the Applicants' stereoscopic 3D consumer delivery system, (U.S. Provisional Application No. 61/223,027, incorporated herein by reference in its entirety), features a base and an enhancement layer. In contrast to the MVC approach, the views may be multiplexed into both layers in order to provide consumers with a base layer that is frame compatible by carrying sub-sampled versions of both views and an enhancement layer that, when combined with the base layer, results in full resolution reconstruction of both views. Frame-compatible formats include side-by-side, over-under, and quincunx/checkerboard interleaved. Some indicative examples are shown in FIGS. 1-2.

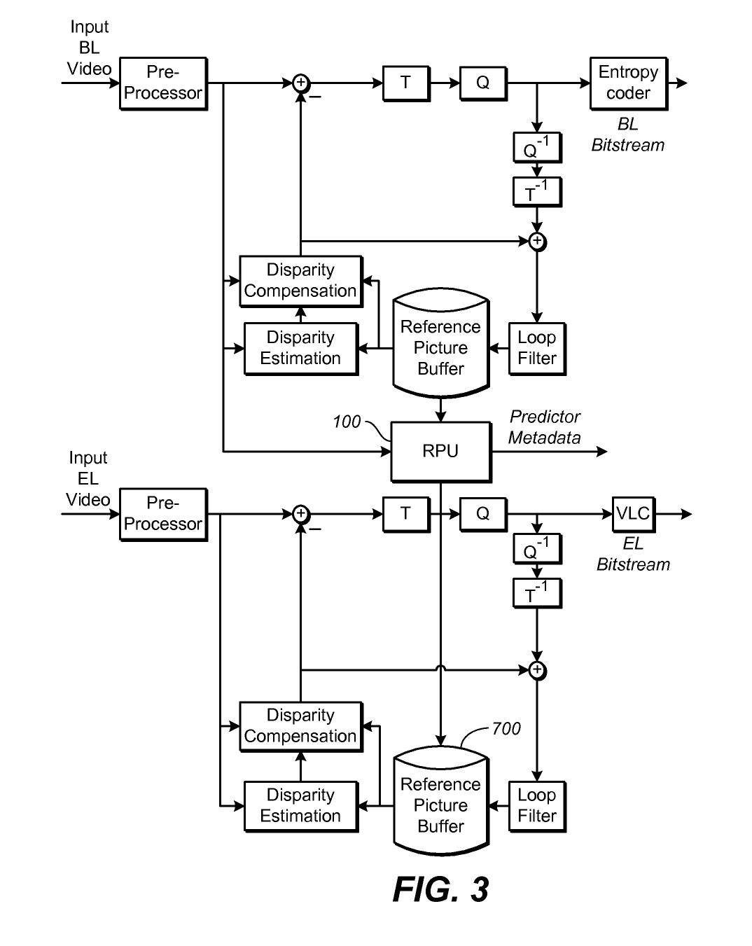

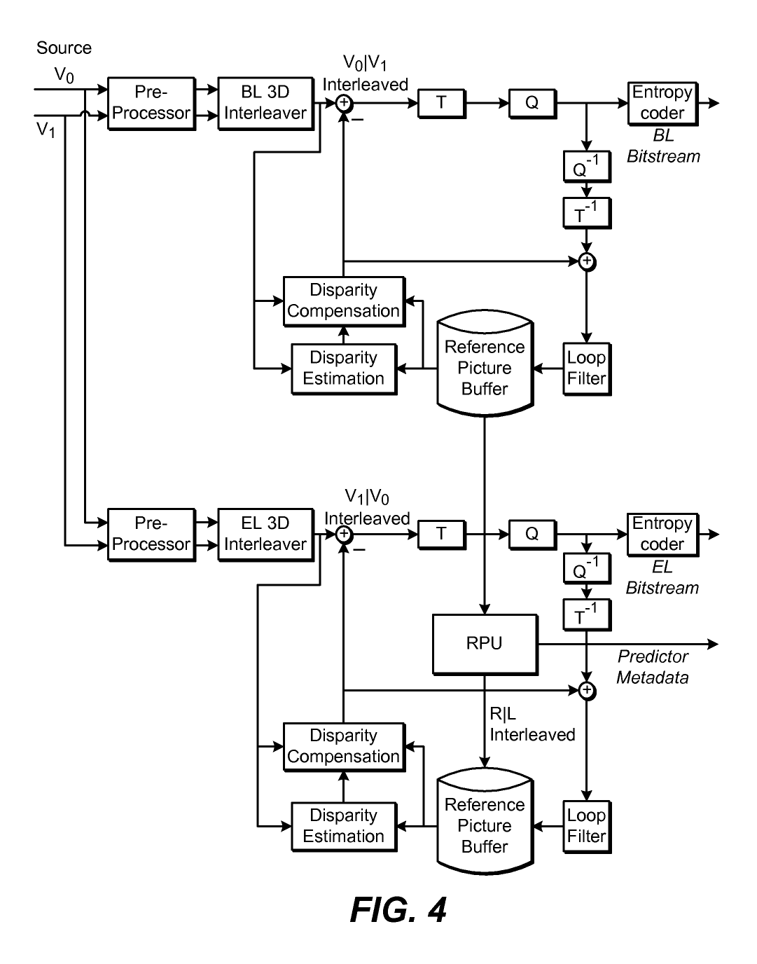

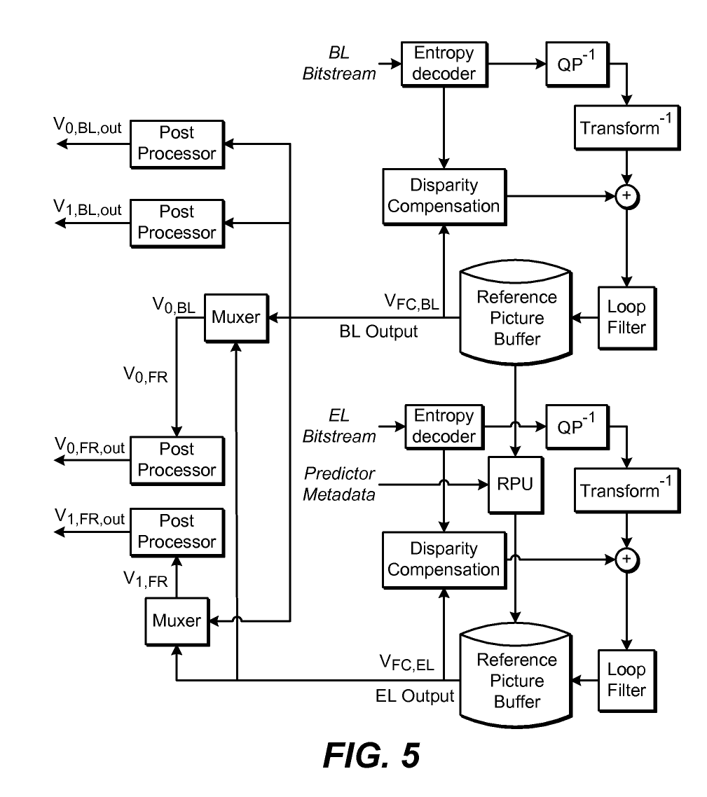

Furthermore, an additional processing stage may be present that processes the base layer decoded frame prior to using it as a motion-compensated reference for prediction of the enhancement layer. Diagrams of an encoder and a decoder for the system proposed in U.S. Provisional Application No. 61/223,027, incorporated herein by reference in its entirety, can be seen in FIGS. 4 and 5, respectively. It should be noted that even a non-frame-compatible coding arrangement such as that of MVC can be enhanced with an additional processing step, also known as a reference processing unit (RPU), that processes the reference taken from the base view prior to using it as a reference for prediction of the dependent view. This is also described in U.S. Provisional Application No. 61/223,027, incorporated herein by reference in its entirety, and is illustrated in FIG. 3.

The frame-compatible techniques of U.S. Provisional Application No. 61/223,027, incorporated herein by reference in its entirety, ensure a frame-compatible base layer and, through the use of the pre-processor/RPU element, succeed in reducing the overhead used to realize full-resolution reconstruction of the stereoscopic views. An example of the process of full-resolution reconstruction for a two-layer system for frame-compatible full-resolution stereoscopic delivery is shown on the left-hand side of FIG. 5. Based on the availability of the enhancement layer, there are two options for the final reconstructed views. They can be either interpolated from the frame compatible output of the base layer V_{FC,BL,out} and optionally post-processed to yield V_{0,BL,out} and V_{1,BL,out} (if for example the enhancement layer is not available or we are trading off complexity), or they can be multiplexed with the proper samples of the enhancement layer to yield a higher representation reconstruction V_{0,FR,out} and V_{1,FR,out} of each view. Note that the resulting reconstructed views in both cases may have the same resolution. However, whereas for the latter case one codes information for all samples (half of them in the base layer and the rest in the enhancement layer for some implementations, though the proportion may differ), in the former case information for half of the samples is available and the rest are interpolated using intelligent algorithms, as discussed and referenced in reference [3] and U.S. Provisional Application No. 61/170,995, incorporated herein by reference in its entirety.

Modern video codecs adopt a multitude of coding tools. These tools include inter and intra prediction. In inter prediction, a block or region in the current picture is predicted using motion compensated prediction from a reference picture that is stored in a reference picture buffer to produce a prediction block or region. One type of inter prediction is uni-predictive motion compensation where the prediction block is derived from a single reference picture. Modern codecs also apply bi-predictive motion compensation where the final prediction block is the result of a weighted linear (or even non-linear) combination of two prediction “hypotheses” blocks, which may be derived from a single reference picture or two different reference pictures. Multi-hypothesis schemes with three or more combined blocks have also been proposed.

It should be noted that regions and blocks are used interchangeably in this disclosure. A region may be rectangular, comprising multiple blocks or even a single pixel, but may also comprise multiple blocks that are simply connected but do not constitute a rectangle. There may also be implementations where a region may not be rectangular. In such cases, a region could be a shapeless group of pixels (not necessarily connected), or could consist of hexagons or triangles (as in mesh coding) of unconstrained size. Furthermore, more than one type of block may be used for the same picture, and the blocks need not be of the same size. Blocks or, in general, structured regions are easier to describe and handle but there have been codecs that utilize non-block concepts. In intra prediction, a block or region in the current picture is predicted using coded (causal) samples of the same picture (e.g., samples from neighboring macroblocks that have already been coded).

After inter or intra prediction, the predicted block is subtracted from an original source block to obtain a prediction residual. The prediction residual is first transformed, and the transform coefficients used in the transformation are quantized. Quantization is generally controlled through use of quantization parameters that control the quantization steps. However, quantization may also be affected by use of quantization offsets that control whether one quantizes towards or away from zero, coefficient thresholding, as well as trellis-based decisions, among others. The quantized transform coefficients, along with other information such as coding modes, motion, block sizes, among others, are coded using an entropy coder that produces the compressed bitstream.

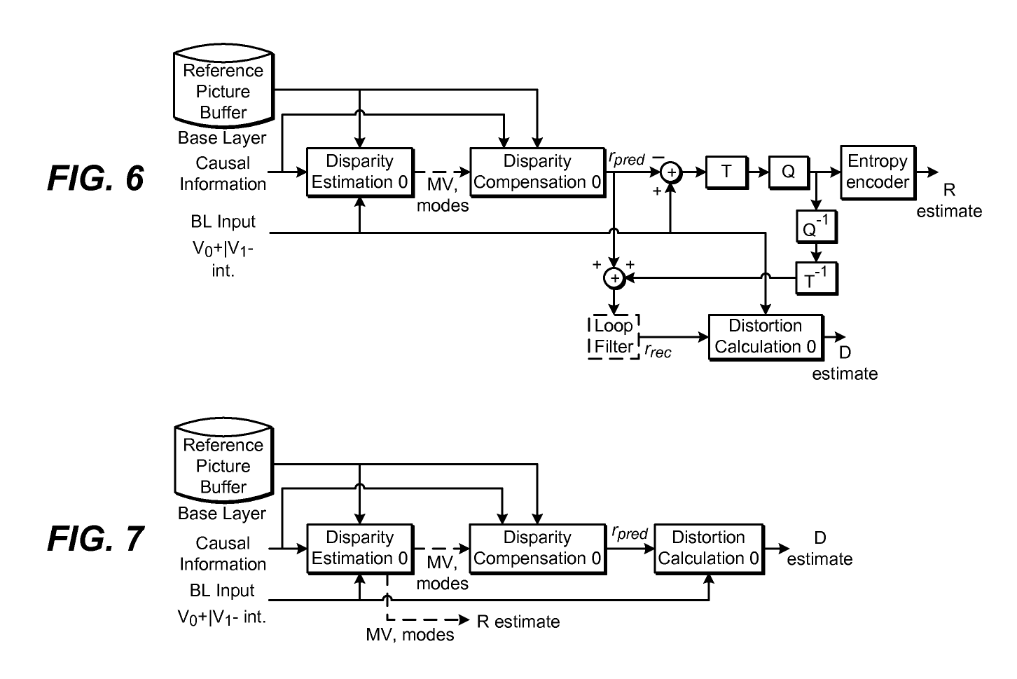

Operations used to obtain a final reconstructed block mirror operations of a decoder: the quantized transformed coefficients (the decoder still needs to decode them from the bitstream) are inverse quantized and inversely transformed (in that order) to yield a reconstructed residual block. This is then added to the inter or intra prediction block to yield the final reconstructed block that is subsequently stored in the reference picture buffer, after an optional in-the-loop filtering stage (usually for the purpose of de-blocking and de-artifacting). This process is illustrated in FIGS. 3, 4, and 5. In FIG. 6, the process of selecting the coding mode (e.g., inter or intra, block size, motion vectors for motion compensation, quantization, etc.) is depicted as “Disparity Estimation 0”, while the process of generating the prediction samples given the selections in the Disparity Estimation module is called “Disparity Compensation 0”.

Disparity estimation includes motion and illumination estimation and coding decision, while disparity compensation includes motion and illumination compensation and generation of intra prediction samples, among others. Motion and illumination estimation and coding decision are critical for compression efficiency of a video encoder. In modern codecs there can be multiple intra prediction modes (e.g., prediction from vertical or from horizontal neighbors) as well as multiple inter prediction modes (e.g., different block sizes, reference indices, or different number of motion vectors per block for multi-hypothesis prediction). Modern codecs use primarily translational motion models. However, more comprehensive motion models such as affine, perspective, and parabolic motion models, among others, have been proposed for use in video codecs that can handle more complex motion types (e.g. camera zoom, rotation, etc.).

In the present disclosure, the term ‘coding decision’ refers to selection of a mode (e.g. inter 4×4 vs intra 16×16) as well as selection of motion or illumination compensation parameters, reference indices, deblocking filter parameters, block sizes, motion vectors, quantization matrices and offsets, quantization strategies (including trellis-based) and thresholding, among other degrees of freedom of a video encoding system. Furthermore, coding decision may also comprise selection of parameters that control pre-processors that process each layer. Thus, motion estimation can also be viewed as a special case of coding decision.

Furthermore, inter prediction utilizes motion and illumination compensation and thus generally needs good motion vectors and illumination parameters. Note that hereforth the term motion estimation will also include the process of illumination parameter estimation. The same is true for the term disparity estimation. Also, the terms motion compensation and disparity compensation will be assumed to include illumination compensation. Given the multitude of coding parameters available, such as use of different prediction methods, transforms, quantization parameters, and entropy coding methods, among others, one may achieve a variety of coding tradeoffs (different distortion levels and/or complexity levels at different rates). By complexity, reference is made to either one or all of the following: implementation, memory, and computational complexity. Certain coding decisions may for example decrease the rate cost and the distortion at the same time at the cost of much higher computational complexity.

The impact of coding tools on complexity is possible to estimate in advance since specification of a decoder is known to an implementer of a corresponding encoder. While particular implementations of the decoder may vary, each of the particular implementations has to adhere to the decoder specification. For many operations, only a few possible implementations methods exist, and thus it is possible to perform complexity analysis on these implementation methods to estimate number of computations (additions, divisions, and multiplications, among others) as well as memory operations (copy and load operations, among others). Aside from memory operations, memory complexity also depends on (additional) amount of memory involved in certain coding tools. Furthermore, both computational and memory complexity impact execution time and power usage. Therefore, in the complexity estimation, these operations are generally weighted using factors that approximate each particular operation's impact on execution time and/or power usage.

Better estimates of complexity may be obtained by creating coding test patterns and testing the software or hardware decoder to build a complexity estimate model. However, these models may often be dependent on the system used to build the model, which is usually difficult to generalize. Implementation complexity may refer, for example, to how many and what kind of transistors are used in implementing a particular coding tool, which would affect the estimate of power usage generated based on the computational and memory complexities.

Distortion is a measure of the dissimilarity or difference of a source reference block or region and some reconstructed block or region. Such measures include full-reference metrics such as the widely used sum-of-squared differences (SSD), its equivalent Peak Signal-to-Noise Ratio (PSNR), or the sum of absolute differences (SAD), the sum of absolute transformed, e.g. hadamard, differences, the structural similarity metric (SSIM), or reduced/no reference metrics that do not consider the source at all but try to estimate the subjective/perceptual quality of the reconstructed region or block itself. Full or no-reference metrics may also be augmented with human visual system (HVS) considerations, such as luminance and contrast sensitivity, contrast and spatial masking, among others, in order to better consider the perceptual impact. Furthermore, a coding decision process may be defined that may also combine one or more metrics in a serial or parallel fashion (e.g., a second distortion metric is calculated if a first distortion metric satisfies some criterion, or both distortion metrics may be calculated in parallel and jointly considered).

Although older systems based their coding decisions primarily on quality performance (minimization of distortion), more modern systems determine the appropriate coding mode using more sophisticated methods that consider both measurements (bit rate and quality/distortion) jointly. Furthermore, one may consider a third measurement involving an estimate of complexity (implementation, computational, and/or memory complexity) for the selected coding mode.

This process is known as the rate-distortion optimization process (RDO) and it has been successfully applied to solve the problem of coding decision and motion estimation in references [4], [5], and [8]. Instead of just minimizing the distortion D or the rate cost R, which are results of a certain motion vector or coding mode selection, one may minimize a joint Lagrangian cost J=D+λR, where) is known as the Lagrangian lambda parameter. Other algorithms such as simulated annealing, genetic algorithms, game theory, among others, may be used to optimize coding decision and motion estimation. When complexity is also considered, the process is known as rate-complexity-distortion optimization (RCDO). In these cases, one may extend the Lagrangian minimization by considering an additional term and an additional Lagrangian lambda parameter as follows: J=D+λ₂C+λ₁R.

A diagram of the coding decision process that uses rate-distortion optimization is depicted in FIG. 6. For each coding mode, one has to derive a distortion and rate cost, which in the case of Lagrangian optimization are used to calculate the Lagrangian cost J. A “disparity estimation 0” module uses as input (a) the source input block or region, which for the case of frame-compatible compression may comprise an interleaved stereo frame pair, (b) “causal information” that includes motion vectors and pixel samples from regions/blocks that have already been coded, and (c) reference pictures from the reference picture buffer (of the base layer in that case). This module then selects the parameters (the intra or inter prediction mode to be used, reference indices, illumination parameters, and motion vectors, etc.) and sends them to the “disparity compensation 0” module, which, using only causal information and information from the reference picture buffer, yields a prediction block or region r_{pred}. This is subtracted from the source block or region and the resulting prediction residual is then transformed and quantized. The transformed and quantized residual then undergoes variable-length entropy coding (VLC) in order to estimate the rate usage.

Rate usage includes bits used to signal the particular coding mode (some are more costly to signal than others), the motion vectors, reference indices (to select the reference picture), illumination compensation parameters, and the transformed and quantized coefficients, among others. To derive the distortion estimate, the transformed and quantized residual undergoes inverse quantization and inverse transformation and is finally added to the prediction block or region to yield the reconstructed block or region for the given coding mode and parameters. This reconstructed block may then optionally undergo loop filtering (to better reflect the operation of the decoder) to yield r_{rec} prior to being fed into a “distortion calculation 0” module together with the original source block. Thus, the distortion estimate D is derived.

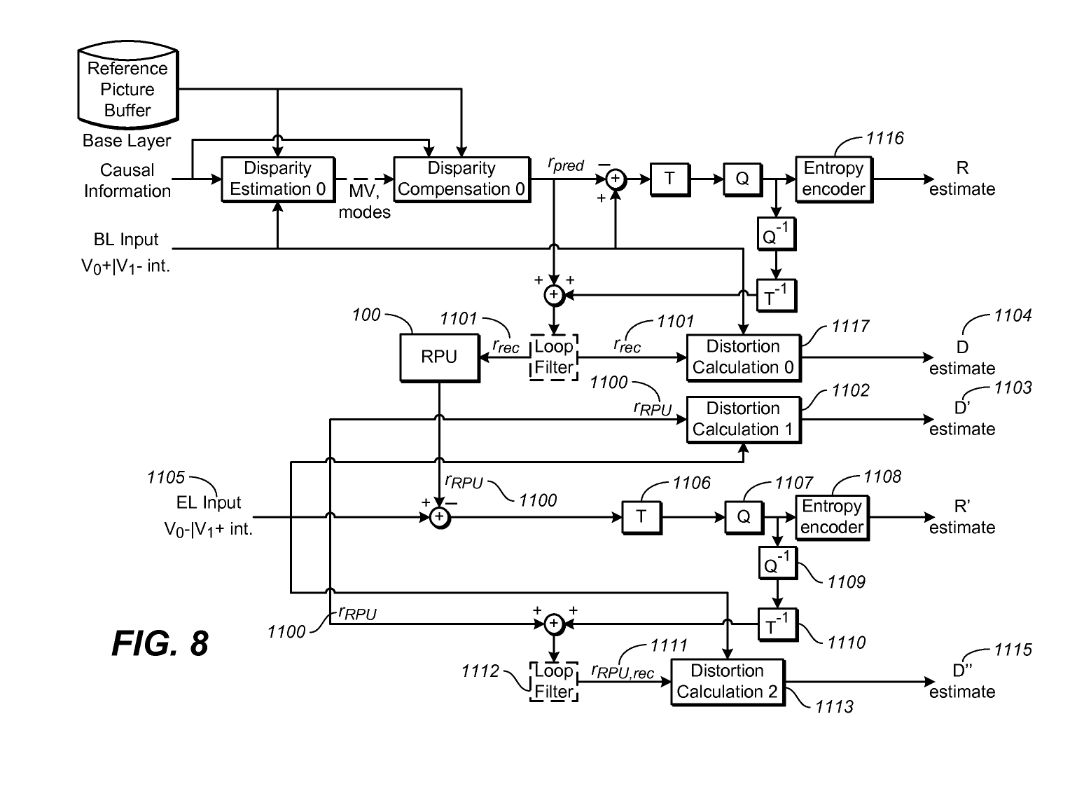

A similar diagram for a fast scheme that avoids full coding and reconstruction is shown in FIG. 7. One can observe that the main difference is that distortion calculation utilizes the direct output of the disparity compensation module, which is the prediction block or region r_{pred}, and that the rate distortion usage usually only considers the impact of the coding mode and the motion parameters (including illumination compensation parameters and the coding of the reference indices). Oftentimes schemes such as these are used primarily for motion estimation due to the low computational overhead; however, one could also apply the schemes to generic coding decision. We assume here that motion estimation is a special case of coding decision. Similarly, one could also use the complex scheme of FIG. 6 to perform motion estimation.

The above optimization strategies have been widely deployed and can produce very good coding results for single-layer codecs. However, in a multi-layer frame-compatible full-resolution scheme as the one to which we are referencing in this disclosure, the layers are not independent from each other as shown in U.S. Provisional Application No. 61/223,027, incorporated herein by reference in its entirety.

FIGS. 3 and 4 show that the enhancement layer has access to additional reference pictures, e.g., the RPU processed pictures that are generated by processing base layer pictures from the base layer reference picture buffer. Consequently, coding choices in the base layer may have an adverse impact on the performance of the enhancement layer. There can be cases where a certain motion vector, a certain coding mode, the selected deblocking filter parameters, the choice of quantization matrices and offsets, and even the use of adaptive quantization or coefficient thresholding may yield good coding results for the base layer but may compromise the compression efficiency and the perceptual quality at the enhancement layer. The coding decision schemes of FIGS. 6 and 7 do not account for this interdependency.

Coding decision and motion estimation for multiple-layer encoders has been studied before. A generic approach that was applied to H.26L-PFGS SNR scalable video encoder can be found in reference [7], where the traditional notion of rate-distortion optimization was extended to also consider the impact of coding decisions in one layer to the distortion and rate usage of its dependent layers. A similar approach, but targeted at Annex G (Scalable Video Coding) of the ITU-T/ISO/IEC H.264/14496-10 video coding standard was presented in reference [6]. In that reference, the Lagrangian cost calculation was extended to include distortion and rate usage terms from dependent layers. Apart from optimization of coding decision and motion estimation, the reference also showed a rate-distortion-optimal trellis-based scheme for quantization that considers the impact to dependent layers.

The present disclosure describes methods that improve and extend traditional motion estimation, intra prediction, and coding decision techniques to account for the inter-layer dependency in frame-compatible, and optionally full-resolution, multiple-layer coding systems that adopt one or more RPU processing elements for predicting representation of a layer given stored reference pictures of another layer. The RPU processing elements may perform filtering, interpolation of missing samples, up-sampling, down-sampling, and motion or stereo disparity compensation when predicting one view from another, among others. The RPU may process the reference picture from a previous layer on a region basis, applying different parameters to each region. These regions may be arbitrary in shape and in size (see also definition of regions for inter and intra prediction). The parameters that control the operation of the RPU processors will be referred to henceforth as RPU parameters.

As previously described, the term ‘coding decision’ refers to selection of one or more of a mode (e.g. inter 4×4 vs intra 16×16), motion or illumination compensation parameters, reference indices, deblocking filter parameters, block sizes, motion vectors, quantization matrices and offsets, quantization strategies (including trellis-based) and thresholding, among various other parameters utilized in a video encoding system. Additionally, coding decision may also involve selection of parameters that control the pre-processors that process each layer.

The following is a brief description of embodiments which will be described in the following paragraphs:
(a) A first embodiment (see Example 1) considering the impact of the RPU.
(b) A second embodiment (see Example 2) building upon the first embodiment and performing additional operations to emulate the encoding process of the dependent layer. This, in turn leading to more accurate distortion and rate usage estimates.
(c) A third embodiment (see Example 3) building upon either of the two embodiments by optimizing the filter, interpolation, and motion/stereo disparity compensation, parameter (RPU parameters) selection used by the RPU.
(d) A fourth embodiment (see Example 4) building upon any one of the three previous embodiments by considering the impact of motion estimation and coding decision in the dependent layer.
(e) A fifth embodiment (see Example 5) considering in addition, the distortion in the full resolution reconstructed picture for each view, for either only the base layer or both the base layer and a subset of the layers, or all of the layers jointly.

Further embodiments will also be shown throughout the present disclosure. Each one of the above embodiments will represent a different performance-complexity trade-off.

### Example 1

In the present disclosure, the terms ‘dependent’ and ‘enhancement’ may be used interchangeably. The terms may be later specified by referring to the layers from which the dependent layer depends. A ‘dependent layer’ is a layer that depends on the previous layer (which may also be another dependent layer) for its decoding. A layer that is independent of any other layers is referred to as the base layer. This does not exclude implementations comprising more than one base layer. The term ‘previous layer’ may refer to either a base or an enhancement layer. While the figures refer to embodiments with just two layers, a base (first) and an enhancement (dependent) layer, this should also not limit this disclosure to two-layer embodiments. For instance, in contrast to that shown in many of the figures, the first layer could be another enhancement (dependent) layer as opposed to being the base layer. The embodiments of the present disclosure can be applied to any multi-layer system with two or more layers.

As shown in FIGS. 3 and 4, the first example considers the impact of RPU (100) on the enhancement or dependent layers. A dependent layer may consider an additional reference picture by applying the RPU (100) on the reconstructed reference picture of the previous layer and then storing the processed picture in a reference picture buffer of the dependent layer. In an embodiment, a region or block-based implementation of the RPU is directly applied on the optionally loop-filtered reconstructed samples r_{rec} that result from the R-D optimization at the previous layer.

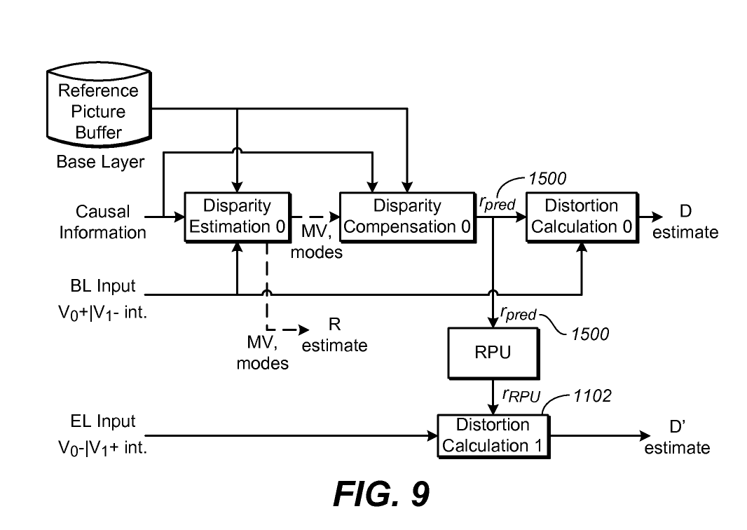

As in FIG. 8, in case of frame-compatible input that includes samples from a stereo frame pair, the RPU yields processed samples r_{RPU} (1100) that comprise a prediction of the co-located block or region in the dependent layer. The RPU may use some pre-defined RPU parameters in order to perform the interpolation/prediction of the EL samples. These fixed RPU parameters may be fixed a priori by user input, or may depend on the causal past. RPU parameters selected during RPU processing of the same layer of the previous frame in coding order may also be used. For the purpose of selecting the RPU parameters from previous frames, it is desirable to select the frame with the most correlation, which is often temporally closest to the frame. RPU parameters used for already processed, possibly neighboring, blocks or regions of the same layer may also be considered. An additional embodiment may jointly consider the fixed RPU parameters and also the parameters from the causal past. The coding decision may consider both and select the one that satisfies the selection criterion (e.g., which, for the case of Lagrangian minimization, involves minimizing the Lagrangian cost).

FIG. 8 shows an embodiment for performing coding decision. The reconstructed samples r_{rec} (1101) at the previous layer are passed on to the RPU that interpolates/estimates the collocated samples r_{RPU} (1100) in the enhancement layer. These may then be passed on to a distortion calculator 1 (1102), together with the original input samples (1105) of the dependent layer to yield a distortion estimate D′ (1103) for the impact on the dependent layer of our encoding decisions at the previous layer.

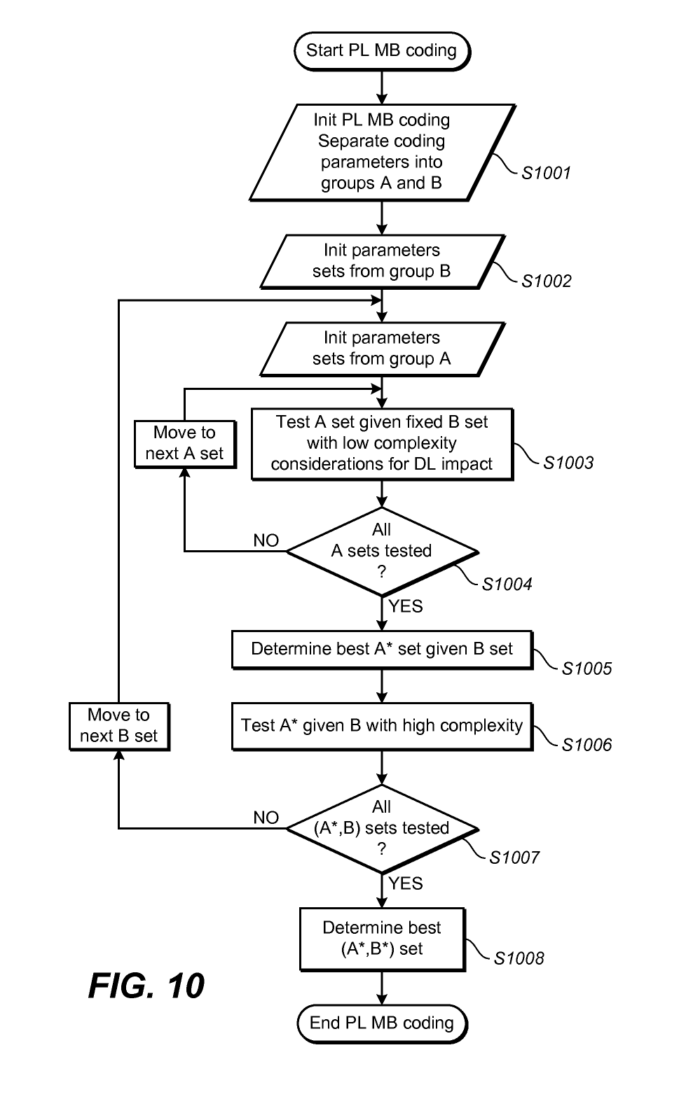

FIG. 9 shows an embodiment for fast calculation of distortion and rate usage for coding decision. Compared to the complex implementation of FIG. 8, the difference is that instead of the previous layer reconstructed samples, the previous layer prediction region or block r_{pred} (1500) is used as the input to the RPU (100). The implementations of FIGS. 8 and 9 represent different trade-offs in terms of complexity and performance.

Another embodiment is a multi-stage process. One could use the simpler method of FIG. 9 (only prediction residuals, not full reconstruction) to decide between 4×4 intra prediction modes, or decide between partition sizes for the 8×8 inter mode, and use the high-complexity method of FIG. 8 with full reconstruction of the residuals to perform the final decision between 8×8 inter or 4×4 intra. The person skilled in the art will understand that any kind of multi-stage decision methods can be used with the teachings of the present disclosure. The entropy encoder in these embodiments may be a relatively low complexity implementation that merely estimates the bits that the entropy encoder would have used.

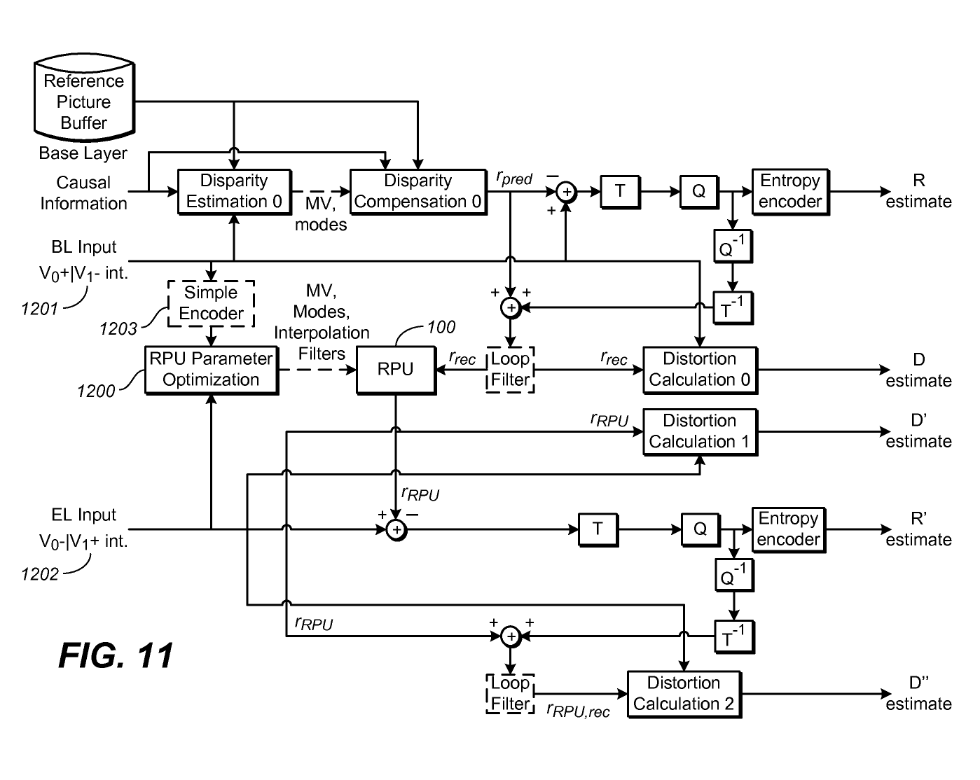

FIG. 10 shows a flowchart illustrating a multi-stage coding decision process. An initial step involves separating (S1001) coding parameters into groups A and B. A first set of group B parameters are provided (S1002). For the first set of group B parameters, a set of group A parameters are tested (S1003) with low complexity considerations for impact on dependent layer or layers. The testing (S1003) is performed until all sets of group A parameters are tested for the first set of group B parameters. An optimal set of group A parameters, A*, is determined (S1005) based on the first set of group B parameters, and the A* is tested (S1006) with high complexity considerations for impact on dependent layer or layers. Each of the steps (S1003, S1004, S1005, S1006) are executed for each set of group B parameters (S1007). Once all group A parameters have been tested for each of the group B parameters, an optimal set of parameters (A*, B*) can be determined (S1008). It should be noted that the multi-stage coding decision process may separate coding parameters into more than two groups.

The additional distortion estimate D′ (1103) may not necessarily replace the distortion estimate D (1104) from the distortion calculator 0 (1117) of the previous layer. D and D′ may be jointly considered in the Lagrangian cost J using appropriate weighting such as: J=w₀×D+w₁×D′+λ×R. In one embodiment, the weights w₀ and w₁ may add up to 1. In a further embodiment, they may be adapted according to usage scenarios such that the weights may be a function of relative importance to each layer. The weights may depend on the capabilities of the target decoder/devices, the clients of the coded bitstreams. By way of example and not of limitation, if half of the clients can decode up to the previous layer and the rest of the clients have access up to and including the dependent layer, then the weights could be set to one-half and one-half, respectively.

Apart from traditional coding decision and motion estimation, the embodiments according to the present disclosure are also applicable to a generalized definition of coding decision that has been previously defined in the disclosure, which also includes parameter selection for the pre-processor for the input content of each layer. The latter enables optimization of the pre-processor at a previous layer by considering the impact of pre-processor parameter (such as filters) selection on one or more dependent layers.

In a further embodiment, the derivation of the prediction or reconstructed samples for the previous layer, as well as the subsequent processing involving the RPU and distortion calculations, among others, may just consider the luma samples, for speedup purposes. When complexity is not an issue, the encoder may consider both luma and chroma for coding decision.

In another embodiment, the “disparity estimation 0” module at the previous layer may consider the original previous layer samples instead of using reference pictures from the reference picture buffer. Similar embodiments can also apply for all disparity estimation modules in all subsequent methods.

### Example 2

As shown at the bottom of FIG. 8, the second example builds upon the first example by providing additional distortion and rate usage estimates by emulating the encoding process at the dependent layer. While the first example compares the impact of the RPU, it avoids the costly derivation of the final dependent layer reconstructed samples r_{RPU,rec}. The derivation of the final reconstructed samples may improve the fidelity of the distortion estimate and thus improve the performance of the rate-distortion optimization process. The output of the RPU r_{RPU} (1100) is subtracted from the dependent layer source (1105) block or region to yield a prediction residual, which is a measure of distortion. This residual is then transformed (1106) and quantized (1107) (using the quantization parameters of the dependent layer). The transformed and quantized residual is then fed to an entropy encoder (1108) that produces an estimate of the dependent layer rate usage R′.

Next, the transformed and quantized residual undergoes inverse quantization (1109) and inverse transformation (1110) and the result is added to the output of the RPU (1100) to yield a dependent layer reconstruction. The dependent layer reconstruction may then be optionally filtered by a loop filter (1112) to yield r_{RPU,rec} (1111) and is finally directed to a distortion calculator 2 (1113) that also considers the source input dependent layer (1105) block or region and yields an additional distortion estimate D″ (1115). An embodiment of this scheme for two layers can be seen at the bottom of FIG. 8. The entropy encoders (1116 and 1108) at the base or the dependent layer may be low complexity implementations that merely estimate number of bits that the entropy encoders would have used. In one embodiment, one could replace a complex method such as arithmetic coding with a lower complexity method such as universal variable length coding (Exponential-Golomb coding). In another embodiment, one could replace an arithmetic or variable-length coding method with a lookup table that provides an estimate of the number of bits that will be used during coding.

Similar to the first example, additional distortion and rate cost estimates may jointly be considered with the previous estimates, if available. The Lagrangian cost J using appropriate weighting may be modified to: J=w₀×D+w₁×D′+w₂×D″+λ₀×R+λ₁×R′. In another embodiment, the lambda values for the rate estimates as well as the gain factors of the distortion estimates may depend on the quantization parameters used in the previous and the dependent layers.

### Example 3

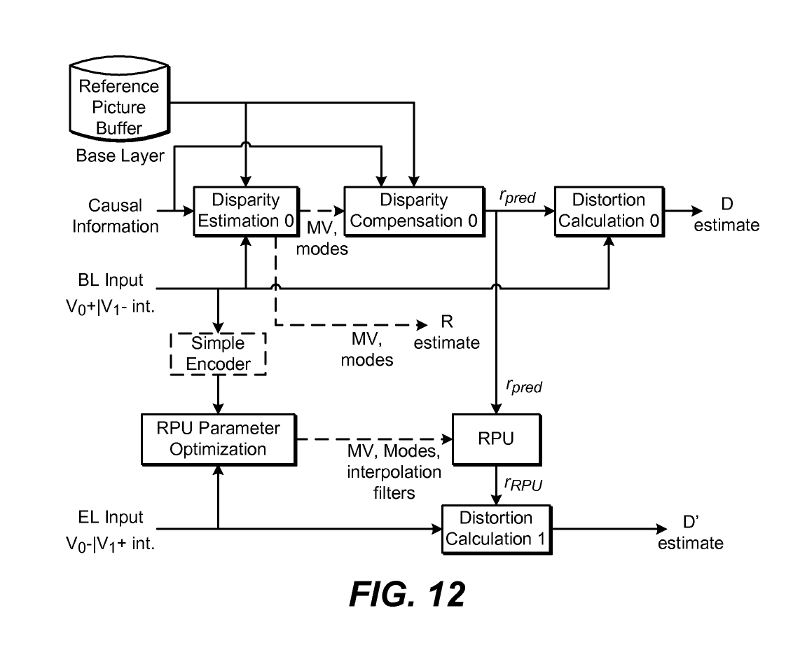

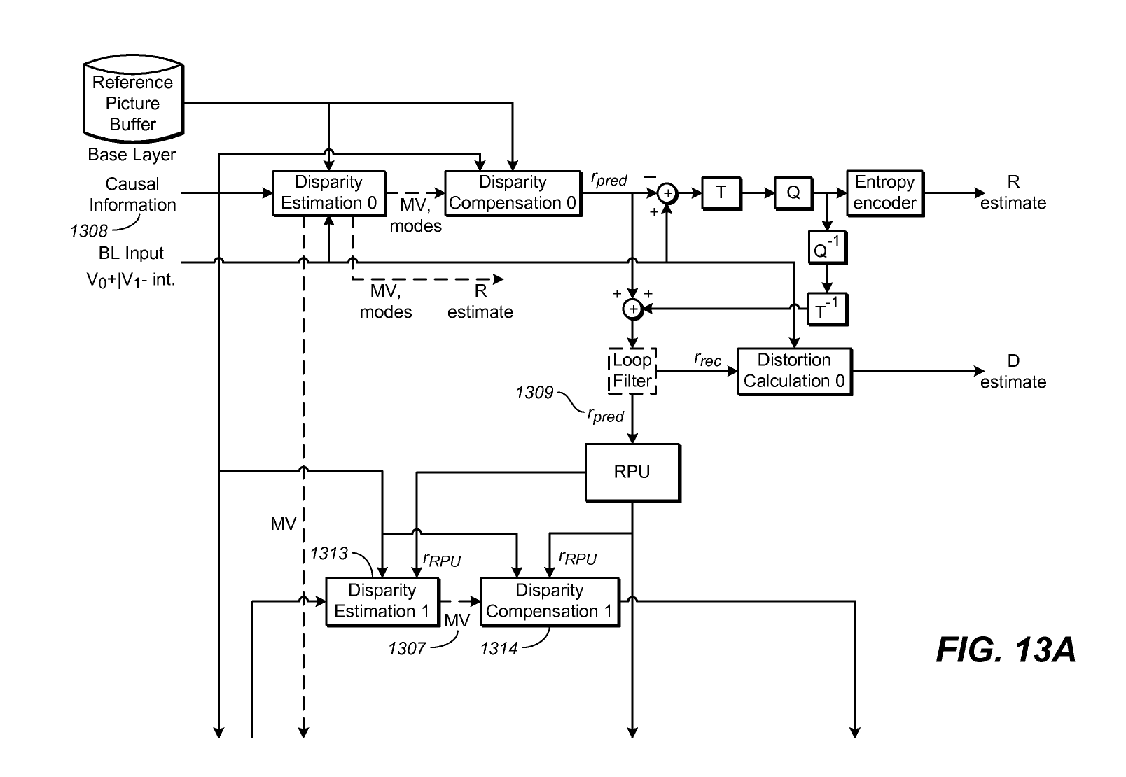

As shown in FIGS. 11 and 12, the third example builds upon examples 1 and 2 by optimizing parameter selection for the RPU. In a practical implementation of a frame-compatible full-resolution delivery system as shown in FIG. 3, the encoder first encodes the previous layer. When the reconstructed picture is inserted in the reference picture buffer, the reconstructed picture is processed by the RPU to derive the RPU parameters. These parameters are then used to guide prediction of a dependent layer picture using as input the reconstructed picture. Once the dependent layer picture prediction is complete, the new picture is inserted into the reference picture buffer of the dependent layer. This sequence of events has the unintended result that the local RPU used for coding decision in the previous layer does not know how the final RPU processing is going to unravel.

In another embodiment, default RPU parameters may be selected. These may be set agnostically. But in some cases, they may be set according to available causal data, such as previously coded samples, motion vectors, illumination compensation parameters, coding modes and block sizes, RPU parameter selections, among others, when processing previous regions or pictures. However, better performance may be possible by considering the current dependent layer input (1202).

To fully consider the impact of the RPU for each coding decision in the previous layer (e.g. the BL or other previous enhancement layers), the RPU processing module may also perform RPU parameter optimization using the predicted or reconstructed block and the source dependent layer (e.g. the EL) block as the input. However, such methods are complex since the RPU optimization process is repeated for each compared coding mode (or motion vector) at the previous layer.

To reduce the computational complexity, an RPU parameter optimization (1200) module that operates prior to the region/block-based RPU (processing module) was included as shown in FIG. 11. The purpose of the RPU parameter optimization (1200) is to estimate the parameters that the final RPU (100) will use when processing the dependent layer reference for use in the dependent layer reference picture buffer. A region may be as large as the frame and as small as a block of pixels. These parameters are then passed on to the local RPU to control its operation.

In another embodiment, the RPU parameter optimization module (1200) may be implemented locally as part of the previous layer coding decision and used for each region or block. In this embodiment of the local approach, each motion block in the previous layer is coded, and, for each coding mode or motion vector, the predicted or reconstructed block is generated and passed through the RPU processor that yields a prediction for the corresponding block. The RPU utilizes parameters, such as filter coefficients, to predict the block in the current layer. As previously discussed, these RPU parameters may be pre-defined or derived through use of causal information. Hence, while coding a block in the previous layer, the optimization module derives.

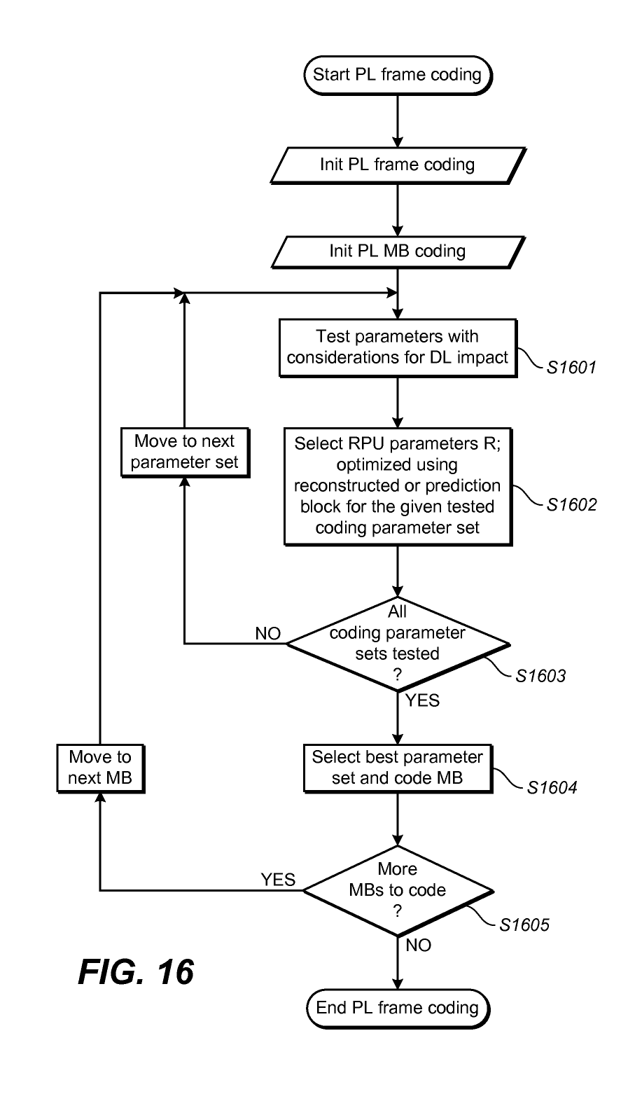

Specifically, FIG. 16 shows a flowchart illustrating the RPU optimization process for this embodiment of the local approach. The process begins with testing (S1601) of a first set of coding parameters for a previous layer comprising, for instance, coding modes and/or motion vectors, that results to a reconstructed or predicted region. Following the testing stage (S1601), a first set of optimized RPU parameters may be generated (S1602) based on the reconstructed or prediction region that is a result of the tested coding parameter set. Optionally the RPU parameter selection stage may also consider original or pre-processed previous layer region values. Distortion and rate estimates are then derived based on the teachings of this disclosure and the determined RPU parameters. Additional coding parameter sets are tested. Once each of the coding parameter sets have been tested, an optimal coding parameter set is selected and the previous layer block or region is coded (S1604) using the optimal parameter set. The previous steps (S1601, S1602, S1603, S1604) are repeated (S1605) until all blocks have been coded.

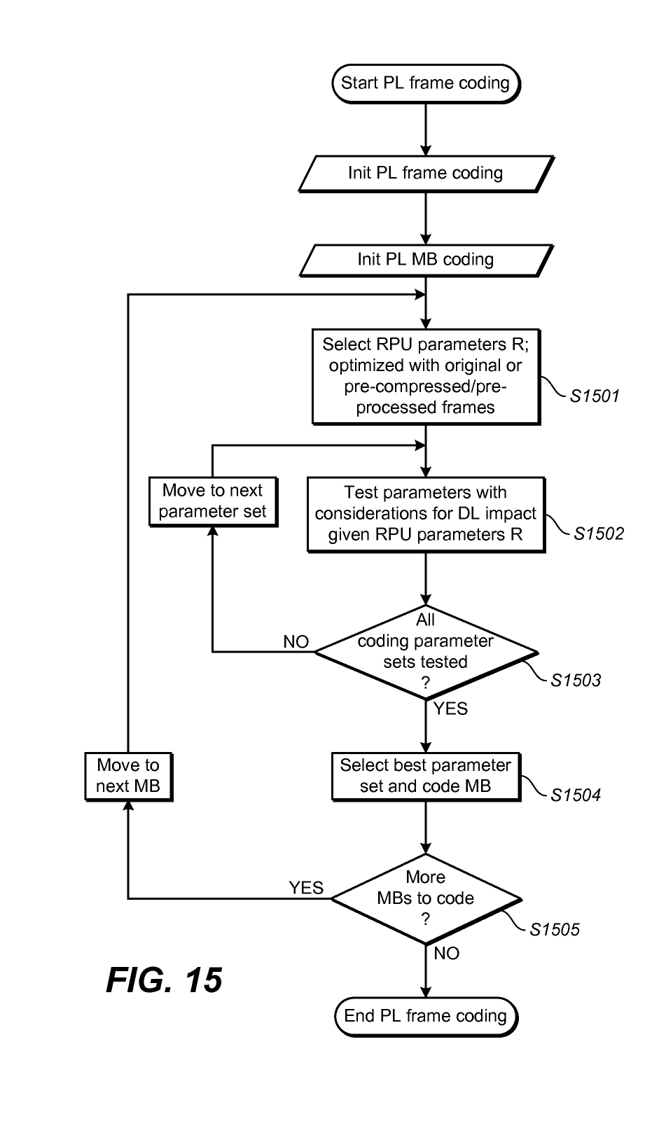

In another embodiment of the local approach, the RPU parameter optimization module (1200) may be implemented prior to coding of the previous layer region. FIG. 15 shows a flowchart illustrating the RPU optimization process in this embodiment of the local approach. Specifically, the RPU parameter optimization is performed once for each block or region based on original or processed original pictures (S1501), and the same RPU parameters obtained from the optimization (S1501) are used for each tested coding parameter set (comprising, for instance, coding mode or motion vector, among others) (S1502). Once a certain previous layer coding parameter set has been tested (S1502) with consideration for impact of the parameter set on dependent layer or layers, another parameter set is similarly tested (S1503) until all coding parameter sets have been tested. In contrast to FIG. 16, the testing of the parameter sets (S1502) does not affect the optimized RPU parameters obtained in the initial step (S1501). Subsequent to the testing of all parameter sets (S1503), an optimal parameter set is selected and the block or region is coded (S1504). The previous steps (S1501, S1502, S1503, S1504) are repeated (S1505) until all blocks have been coded.

In a frame-based embodiment, this pre-predictor could use as input the source dependent layer input (1202) and the source previous layer input (1201). Additional embodiments are defined where instead of the original previous layer input, we perform a low complexity encoding operation that uses quantization similar to that of the actual encoding process and produces a previous layer “reference” that is closer to what the RPU would actually use.

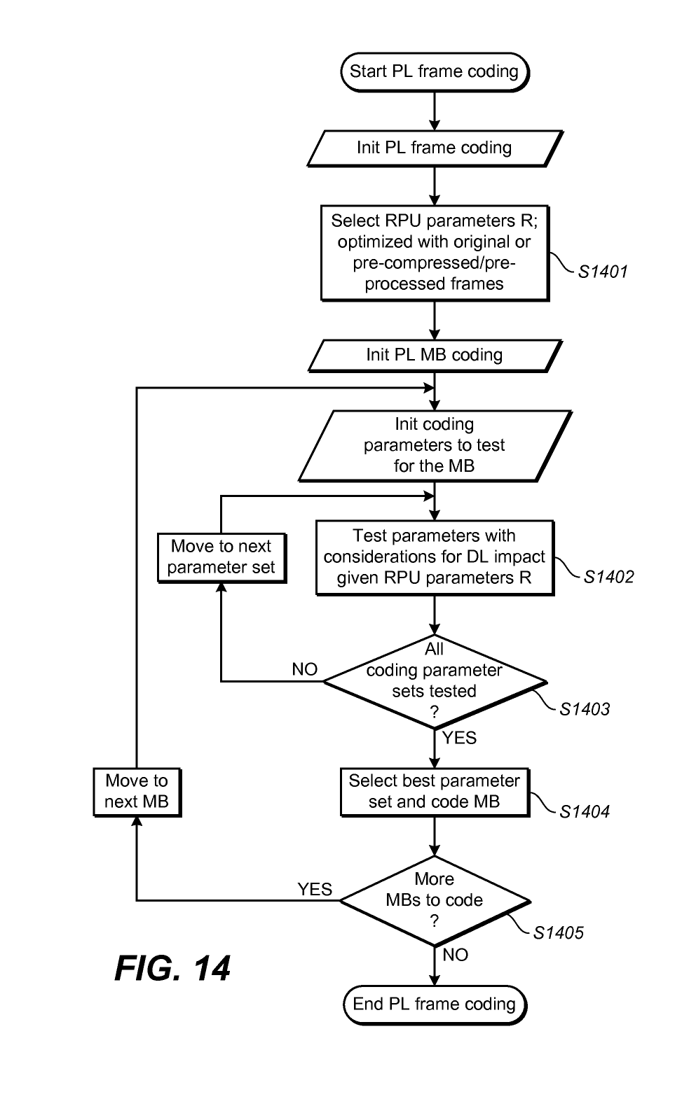

FIG. 14 shows a flowchart illustrating the RPU optimization process in a frame-based embodiment. In the frame level approach, only original pictures or processed original pictures are available since RPU optimization occurs prior to encoding of the previous layer. Specifically, RPU parameters are optimized (S1401) based only on the original pictures or processed original pictures. Subsequent to the RPU parameter optimization (S1401), a coding parameter set is tested (S1402) with consideration on impact of the parameter set on dependent layer or layers. Additional coding parameter sets are similarly tested (S1403) until all parameter sets have been tested. For all tested coding parameter sets the same fixed RPU parameters estimated in S1401 are used to model the dependent layer RPU impact. Similar to FIG. 15 and in contrast to FIG. 16, the testing of the parameter sets (S1602) does not affect the optimized RPU parameters obtained in the initial optimization step (S1601). Subsequent to the testing of all parameter sets (S1403), an optimal coding parameter set is selected and the block is coded (S1404). The previous steps (S1401, S1402, S1403, S1404) are repeated (S1405) until all blocks have been coded.

The embodiment of FIG. 15 lowers complexity relative to the local approach shown in FIG. 16 where optimized parameters are generated for each coding mode or motion vector that form a coding parameter set. The selection of the particular embodiment may be a matter of parallelization and implementation requirements (e.g., memory requirements for the localized version would be lower, while the frame-based version could be easily converted into a different processing thread and run while coding, for example, the previous frame in coding order; the latter is also true for the second local-level embodiment). Additionally, in an embodiment that implements the local approach, the RPU optimization module could use reconstructed samples r_{rec} or predicted samples r_{pred} as input to the RPU processor that generates a prediction of the dependent layer input. However, there are cases where a frame-based approach may be desirable in terms of compression performance because the region size of the encoder and the region size of the RPU may not be equal. For example, the RPU may use a much larger size. In such a case the selections that a frame-based RPU optimization module makes may be closer to the final outcome. An embodiment with a slice-based (i.e., horizontal regions) RPU optimization module would be more amenable to parallelization, using, for instance, multiple threads.

An embodiment, which applies to both the low complexity local-level approach as well as the frame-level approach, may use an intra-encoder (1203) where intra prediction modes are used to process the input of the previous layer prior to using it as input to the RPU optimization module. Other embodiments could use ultra low-complexity implementations of a previous layer encoder to simulate a similar effect. Complex and fast embodiments for the frame-based implementation are illustrated in FIGS. 11 and 12, respectively.

For some of the above embodiments, the estimated RPU parameters obtained during coding decision for the previous layer may differ from the ones actually used during the final RPU optimization and processing. Generally, the final RPU optimization occurs after the previous layer has been coded. The final RPU optimization generally considers the entire picture. In an embodiment, information (spatial and temporal coordinates) is gathered from past coded pictures regarding these discrepancies and the information is used in conjunction with the current parameter estimates of the RPU optimization module in order to estimate the final parameters that are used by the RPU to create the new reference, and these corrected parameters are used during the coding decision process.

In another embodiment where the RPU optimization step considers the entire picture prior to starting the coding of each block in the previous layer (as in the frame-level embodiment of FIG. 14), information may be gathered about the values of the reconstructed pixels of the previous layer following its coding and the values of the pixels used to drive the RPU process, which may either be the original values or values processed to add quantization noise (compression artifacts). This information may then be used in a subsequent picture in order to modify the quantization noise process so that the samples used during RPU optimization more closely resemble coded samples.

### Example 4

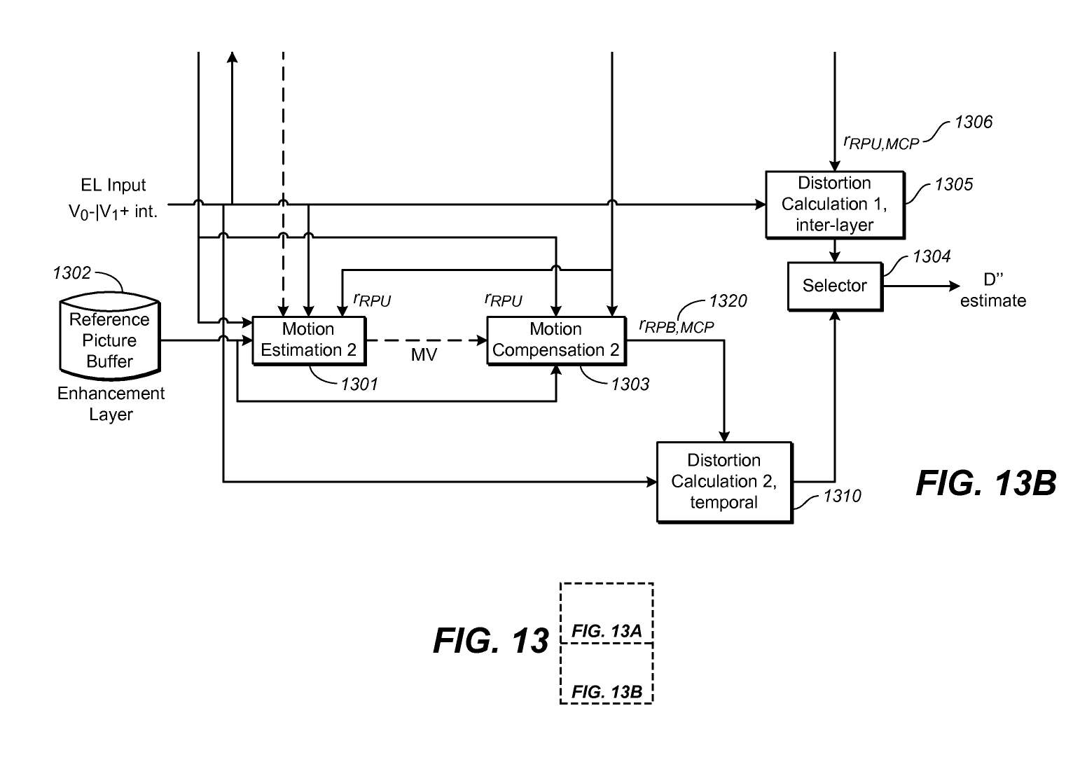

As shown in FIG. 13, the fourth example builds upon any one of the three previous examples by considering the impact of motion estimation and coding decision in the dependent layer. FIG. 3 shows that the reference picture that is produced by the RPU (100) is added to the dependent layer's reference picture buffer (700). However, this is just one of the reference pictures that are stored in the reference picture buffer, which may also contain the dependent layer reconstructed pictures belonging to the previous frames (in coding order). Oftentimes such a reference, or references in the case of bi-predictive or multi-hypothesis motion estimation (referred to as the “temporal” references), may be chosen in place of (in uni-predictive motion estimation/compensation) or in combination with (in multi-hypothesis/bi-predictive motion estimation/compensation) the “inter-layer” reference (the reference being generated by the RPU). For bi-predictive motion estimation, one block may be chosen from an inter-layer reference while another block may be chosen from a “temporal” reference. Consider, for instance, a scene change in a video, in which case the temporal references would have low (or no) temporal correlation with the current dependent layer reconstructed pictures while the inter-layer correlation would generally be high. In this case, the RPU reference will be chosen. Consider a case for a very static scene, in which case the temporal references would have high temporal correlation with the current dependent layer reconstructed pictures; in particular, the temporal correlation may be higher than that of the inter-layer RPU prediction. Consequently, such a choice of utilizing “temporal” references in place of or in combination with “inter-layer” references would generally render previously estimated D′ and D″ distortions unreliable. Thus, in example 4, techniques are proposed that enhance coding decisions at the previous layer by considering the reference picture selection and coding decision (since intra prediction may also be considered) at the dependent layer.

A further embodiment can decide between two distortion estimates at the dependent layer. The first type of distortion estimate is the one estimated in examples 1-3. This corresponds to the inter-layer reference.

The other type of distortion at the previous layer corresponds to the temporal reference as shown in FIG. 13. This distortion is estimated such that a motion estimation module 2 (1301) takes as input temporal references from the dependent layer reference picture buffer (1302), the processed output r_{RPU} of the RPU processor, causal information that may include RPU-processed samples and coding parameters (such as motion vectors since they enhance rate estimation) from the neighborhood of the current block or region, and the source dependent layer input block, and determines the motion parameters that best predict the source block given the inter-layer and temporal references. The causal information can be useful in order to perform motion estimation. For the case of uni-predictive motion compensation, the inter-layer block r_{RPU} and the causal information are not required. However, for bi-predictive or multi-hypothesis prediction they also have to be jointly considered to produce the best possible prediction block. The motion parameters as well as the temporal references, the inter-layer block, and the causal information are then passed on to a motion compensation module 2 (1303) that yields the prediction region or block r_{RPB,MCP} (1320). The distortion related to the temporal reference is then calculated (1310) using that predicted block or region r_{RPB,MCP} (1320) and the source input dependent layer block or region. The distortions corresponding to the temporal (1310) and the inter-layer distortion calculation block (1305) are then passed on to a selector (1304), which is a comparison module that selects the block (and the distortion) using criteria that resemble those of the dependent layer encoder. These criteria may also include Lagrangian optimization where, for example, the cost of the motion vectors for the dependent layer reference is also taken into account.

In a simpler embodiment, the selector module (1304) will select the minimum of the two distortions. This new distortion value can then be used in place of the original inter-layer distortion value (as determined with examples 1-3). An illustration of this embodiment is shown at the bottom of FIG. 13.

Another embodiment may use the motion vectors corresponding to the same frame from the previous layer encoder. The motion vectors may be used as is or they may optionally be used to initialize and thus speed up the motion search in the motion estimation module. Motion vectors also refer to illumination compensation parameters, deblocking parameters, quantization offsets and matrices, among others. Other embodiments may conduct a small refinement search around the motion vectors provided by the previous layer encoder.

An additional embodiment enhances the accuracy of the inter-layer distortion through the use of motion estimation and compensation. Until now it has been assumed that the output r_{RPU} of the RPU processor is used as is to predict the dependent layer input block or region. However, since the reference that is produced by the RPU processor is placed into the reference picture buffer, it will be used as a motion compensated reference picture. Hence, a motion vector other than all-zero (0,0) may be used to derive the prediction block for the dependent layer.

Although the motion vector (MV) will be close to zero for both directions most of the time, non-zero cases are also possible. To account for these motion vectors, a disparity estimation module 1 (1313) is added that takes as input the output r_{RPU} of the RPU, the input dependent layer block or region, and causal information that may include RPU-processed samples and coding parameters (such as motion vectors since they enhance rate estimation) from the neighborhood of the current block or region. The causal information can be useful in order to perform motion estimation.

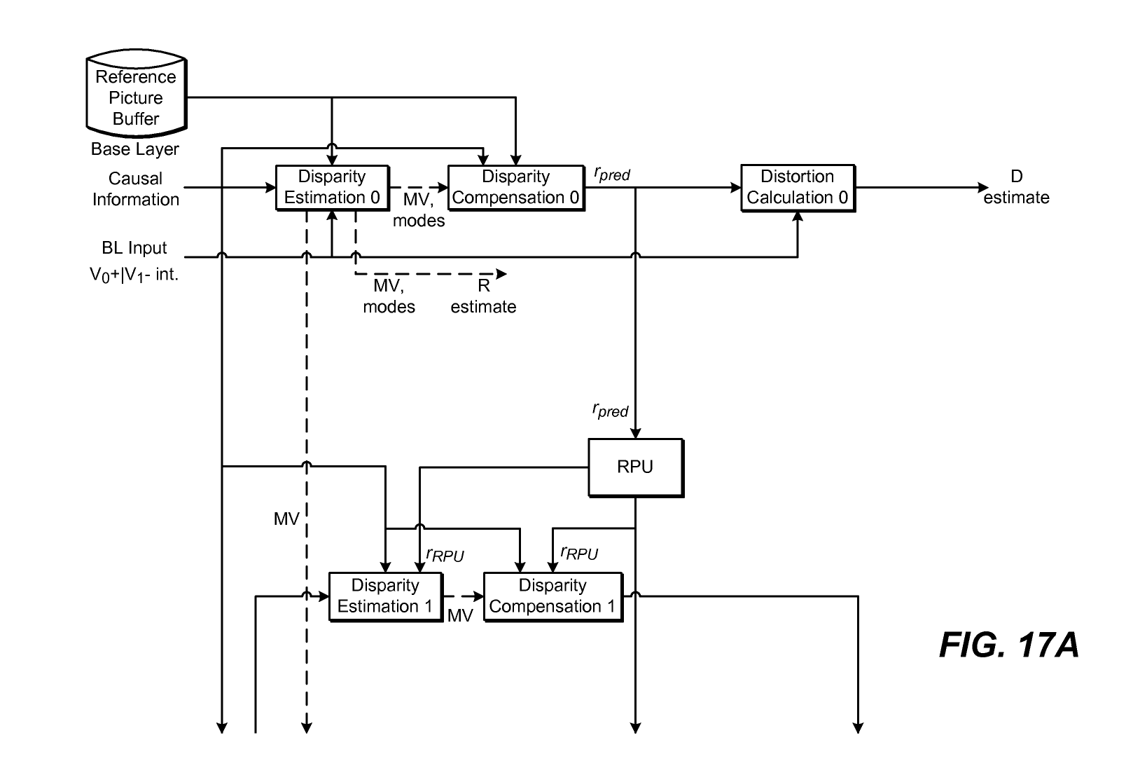

As shown in FIG. 13, the dependent layer input block is estimated using as motion-compensated reference the predicted block r_{RPU} and final RPU-processed blocks from its already coded surrounding causal area. The estimated motion vector (1307) along with the causal neighboring samples (1308) and the predicted block or region (1309) are then passed on to a final disparity compensation module 1 (1314) to yield the final predicting block r_{RPU,MCP} (1306). This block is then compared in a distortion calculator (1305) along with the dependent layer input block or region to produce the inter-layer distortion. An illustration of another embodiment for a fast calculation for enhancing coding decision at the previous layer is shown in FIG. 17.

In another embodiment, the motion estimation module 1 (1301) and motion compensation module 1 (1303) may also be generic disparity estimation and compensation modules that also perform intra prediction using the causal information, since there is always the case that intra prediction may perform better in terms of rate distortion performance than inter prediction or inter-layer prediction.

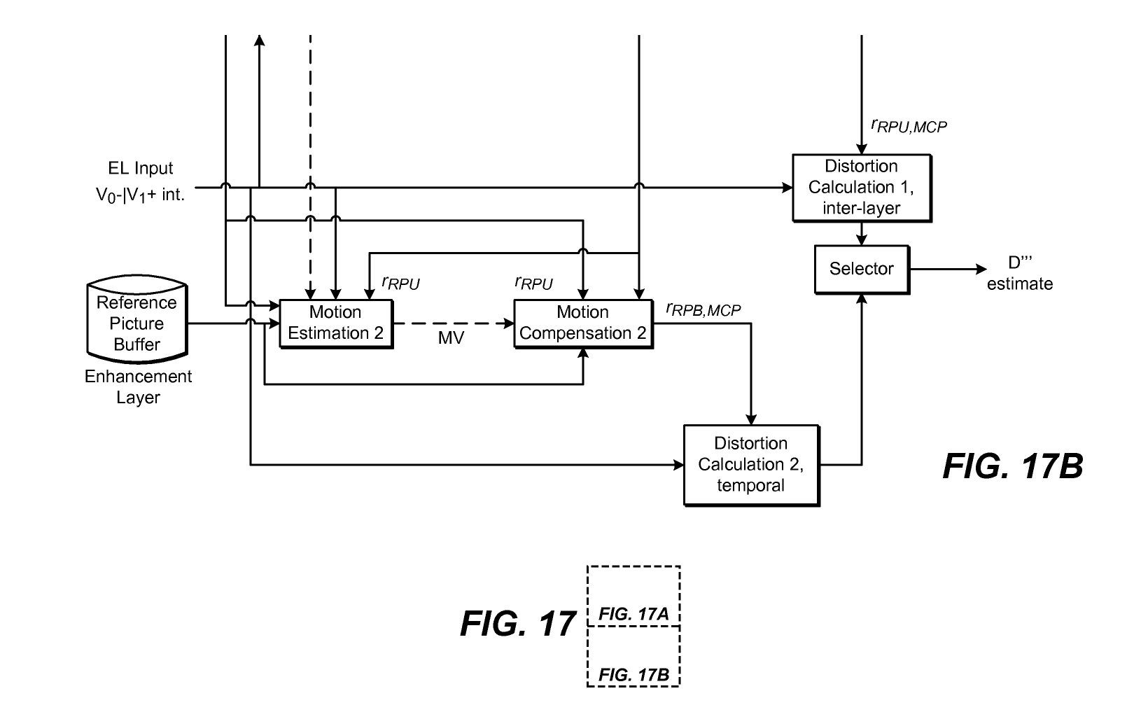

FIG. 18 shows a flowchart illustrating an embodiment that allows use of non-causal information from modules 1 and 2 of the motion estimation (1313, 1301) of FIG. 13 and the motion compensation (1314, 1303) of FIG. 13 through multiple coding passes of the previous layer. A first coding pass can be performed possibly without any consideration for the impact on the dependent layers (S1801). The coded samples are then processed by the RPU to form a preliminary RPU reference for its dependent layer (S1802). In the next coding pass, the previous layer is coded with considerations for the impact on the dependent layer or layers (S1803). Additional coding passes (S1804) may be conducted to yield improved motion-compensation consideration for the impact on the dependent layer or layers. During the encoding process of the previous layer, the motion estimation module 1 (1313) and the motion compensation module 1 (1314) as well as the motion estimation module 2 (1301) and the motion compensation module 2 (1303) can now use the preliminary RPU reference as non-causal information.

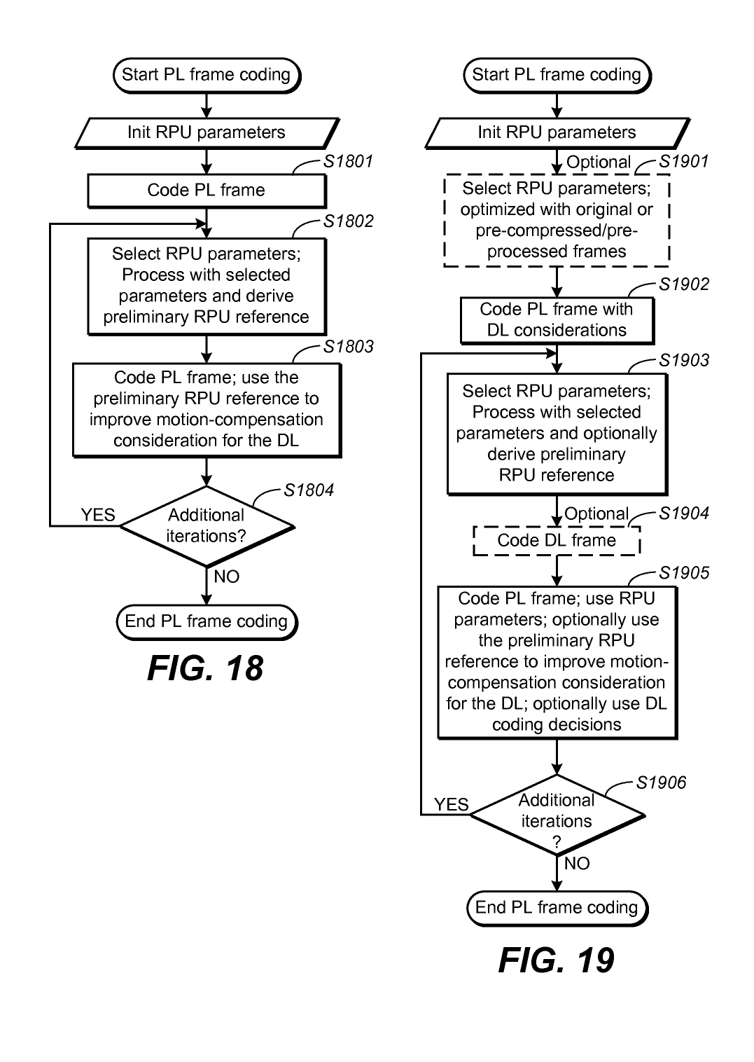

FIG. 19 shows a flowchart illustrating another embodiment, where an iterative method performs multiple coding passes for both the previous and, optionally, the dependent layers. In an optional, initial step (S1901), a set of optimized RPU parameters may be obtained based on original or processed original parameters. More specifically, the encoder may use a fixed RPU parameter set or optimize the RPU using original previous layer samples or pre-quantized samples. In a first coding pass (S1902), the previous layer is encoded by possibly considering the impact on the dependent layer. The coded picture of the previous layer is then processed by the RPU (S1903) and yields the dependent layer reference picture and RPU parameters. Optionally, a preliminary RPU reference may also be derived in step S1903. The actual dependent layer may then be fully encoded (S1904). In the next iteration (S1905), the previous layer is re-encoded by considering the impact of the RPU where now the original fixed RPU parameters are replaced by the RPU parameters derived in the previous coding pass of the dependent layer. Also, the coding mode selection at the dependent layer of the previous iteration may be considered since the use of temporal or intra prediction will affect the distortion for the samples of the dependent layer. Additional iterations (S1906) are possible. Iterations may be terminated after executing a certain number of iterations or once certain criteria are fulfilled, for example and not of limitation, the coding results and/or RPU parameters for each of the layers change little or converge.

In another embodiment, the motion estimation module 1 (1313) and the motion compensation module 1 (1314) as well as the motion estimation module 2 (1301) and the motion compensation module 2 (1303) do not necessarily just consider causal information around the RPU-processed block. One option is to replace this causal information by simply using the original previous layer samples and performing RPU processing to derive neighboring RPU-processed blocks. Another option is to replace original blocks with pre-quantized blocks that have compression artifacts similar to example 2. Thus, even non-causal blocks can be used during the motion estimation and motion compensation process. In a raster-scan coding order, blocks on the right and on the bottom of the current block can be available as references.

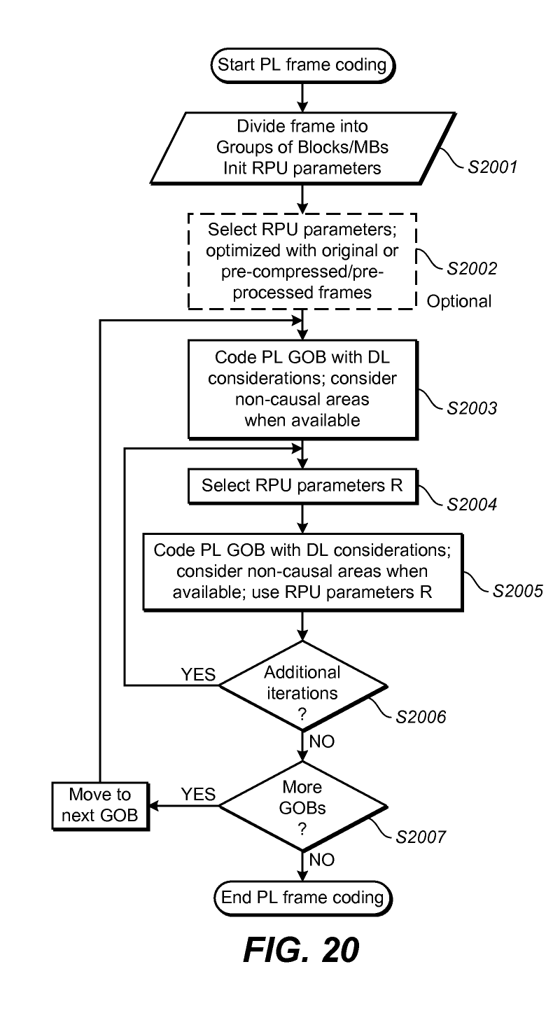

Another embodiment optimizes coding decisions for the previous layer, and also addresses the issue of unavailability of non-causal information, by adopting an approach with multiple iterations on a regional level. FIG. 20 shows a flowchart illustrating such an embodiment. The picture is first divided into groups of blocks or macroblocks (S2001) that contain at least two blocks or macroblocks that are spatial neighbors. These groups may also be overlapping each other. Multiple iterations are applied for each one of these groups. In an optional step (S2002), a set of optimized RPU parameters may be obtained using original or processed original parameters. More specifically, the encoder may use a fixed RPU parameter set or optimize the RPU using original previous layer samples or pre-quantized samples. In a first iteration (S2003), the group of blocks of the previous layer is encoded by considering the impact on the dependent layer blocks for which sufficient neighboring block information is available. The coded group of the previous layer is then processed by the RPU (S2004) and yields RPU parameters. In a next iteration, the previous layer is then re-encoded (S2005) by considering the impact of the RPU, where now the original fixed parameters are replaced by the parameters derived in the previous coding pass of the dependent layer. Additional iterations (S2006) are possible. Iterations may be terminated after executing a certain number of iterations once certain criteria are fulfilled, for example and not of limitation, the coding results and/or RPU parameters for each of the layers changes little or converges.

After coding of the current group terminates, the encoder repeats (S2007) the above process (S2003, S2004, S2005, S2006) with the next group in coding order until the entire previous layer picture has been coded. Each time a group is coded all blocks in the group are coded. This means that, for overlapping groups, overlapping blocks will be recoded again. The advantage is that boundary blocks that had no non-causal information when coded in one group may have access to non-causal information in a subsequent overlapping group.

It should be reiterated that these groups may also be overlapping each other. For instance, consider a case where each overlapping group of regions contains two horizontally neighboring macroblocks or regions. Let region 1 contain macroblocks 1, 2, and 3, while region 2 contains macroblocks 2, 3, and 4. Also consider the following arrangement: macroblock 2 is located toward the right of macroblock 1, macroblock 3 is located toward the right of 2, and macroblock 4 is located toward the right of macroblock 3. All four macroblocks lie along the same horizontal axis.

During a first iteration that codes region 1, macroblocks 1, 2, and 3 are coded (optionally with dependent layer impact considerations). Impact of motion compensation on an RPU processed reference region is estimated. However, for non-causal regions, only RPU processed samples that take as an input either original previous layer samples or pre-processed/pre-compressed samples may be used in the estimation. The region is then processed by an RPU, which yields processed samples for predicting the dependent layer. These processed samples are then buffered.

During an additional iteration that re-encodes region 1, specifically during coding of macroblock 1, the dependent layer impact consideration is more accurate since buffered RPU processed region from macroblock 2 may be used to estimate the impact of motion compensation. Similarly, re-encoding macroblock 2 benefits from buffered RPU processed samples from macroblock 3. Furthermore, during a first iteration of region 2, specifically during coding of macroblock 2, information (including RPU parameters) from previously coded macroblock 3 (in region 1) may be used.

### Example 5

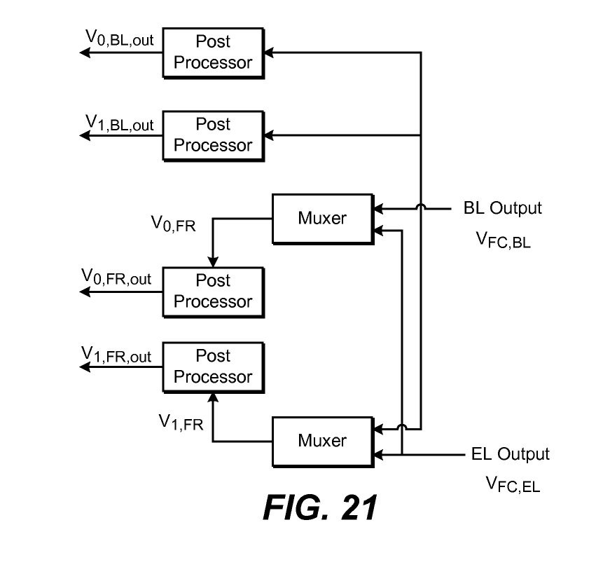

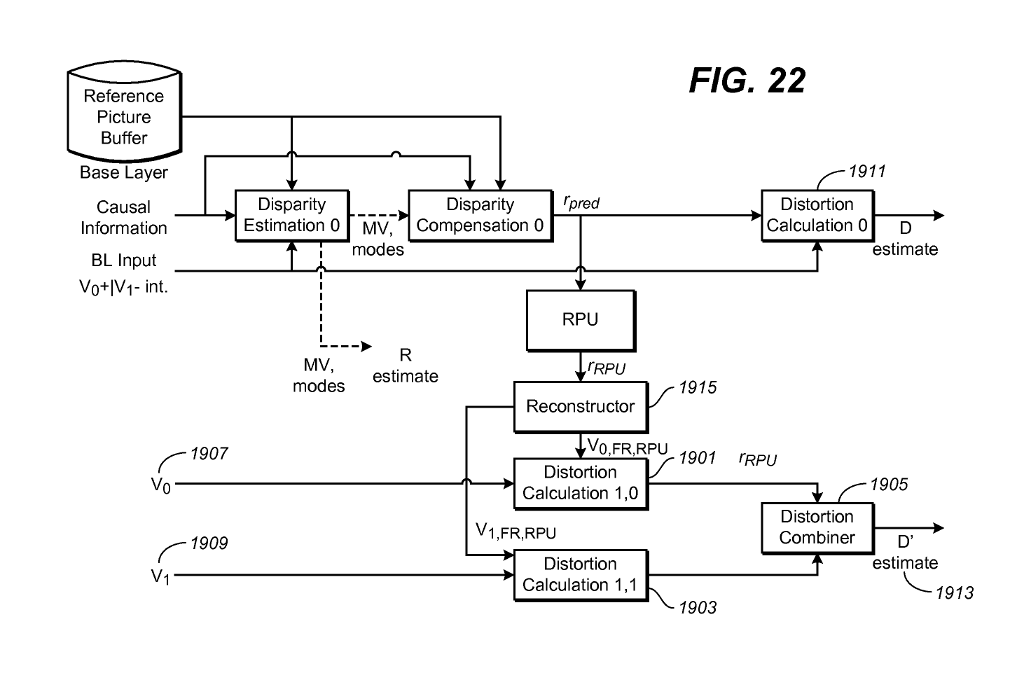

In examples 1-4 described above, distortion calculations were referred with respect to either a previous layer or a dependent layer source. However, for example in cases where each layer packages a stereo frame image pair, it may be more beneficial, especially for perceptual quality, to calculate distortion for the final up-sampled full resolution pictures (e.g., left and right views). An example module that creates full-resolution reconstruction (1915) for frame-compatible full-resolution video delivery is shown in FIGS. 21 and 22. Full resolution reconstructions are possible even if only the previous layer is available, and involve interpolation of the missing samples as well as filtering and optionally motion or stereo disparity compensation. In cases where all layers are available, samples from all layers are combined and re-processed to yield full resolution reconstructed views. Said processing may entail motion or disparity compensation, filtering, and interpolation, among other operations. Such a module could also operate on a region or block basis. Thus, additional embodiments are possible where instead of calculating the distortion, for example and not of limitation, of the RPU output r_{RPU} with respect to the dependent layer input, full resolution pictures, e.g., views, may first be interpolated using region or block r_{RPU,rec} or r_{RPU/RPB,MCP} or r_{RPU} as the dependent layer input and using region or block r_{rec} or r_{pred} as the previous layer input. The full resolution blocks or regions of the views may then be compared with the original source blocks or regions of the views (prior to them being filtered, processed, down-sampled, and multiplexed to create the inputs to each layer).

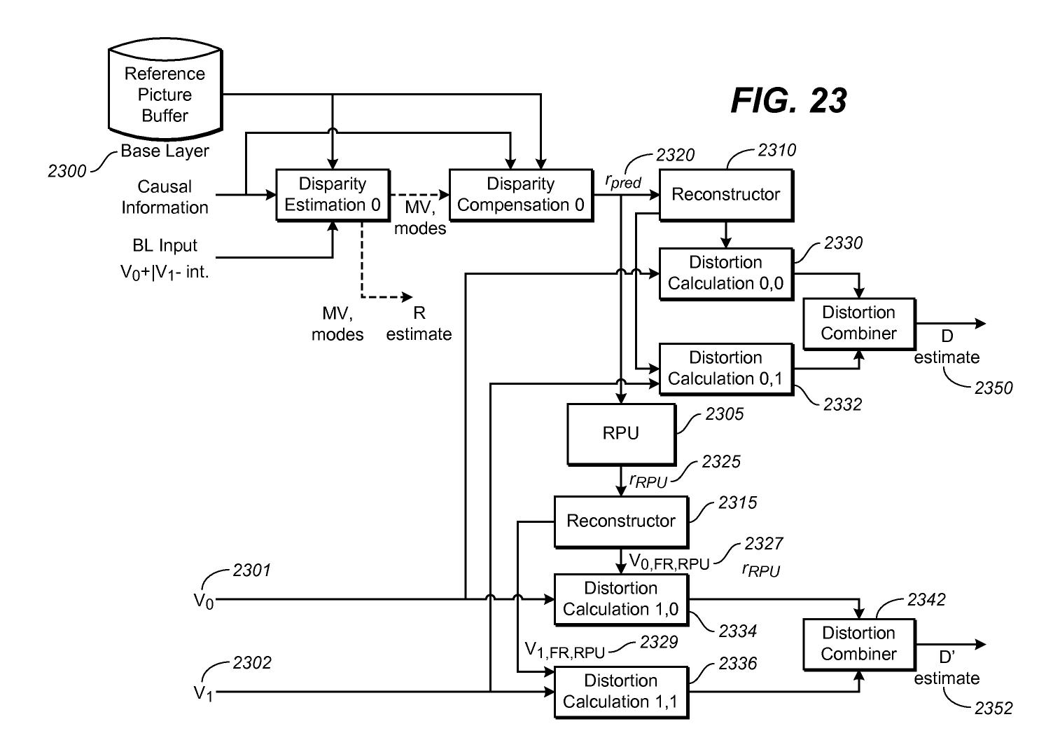

An embodiment, shown in FIG. 23, could involve just distortion and samples from a previous layer (2300). Specifically, a prediction block or region r_{pred} (2320) is fed into an RPU (2305) and a previous layer reconstructor (2310). The RPU (2305) outputs r_{RPU} (2325), which is fed into a current layer reconstructor (2315). The current layer reconstructor (2315) generates information V_{0,FR,RPU} (2327) and V_{1,FR,RPU} (2329) pertaining to a first view V₀ (2301) and a second view V₁ (2302). It should be noted that although the term ‘view’ is used, a view refers to any data construction that may be processed with one or more additional data constructions to yield a reconstructed image.

It should be noted that although a prediction block or region r_{pred} (2320) is used in FIG. 23, a reconstructed block or region r_{rec} may be used instead in either layer. The reconstructed block or region r_{rec} takes into consideration effects of forward transformation and forward quantization (and corresponding inverse transformation and inverse quantization) as well as any, generally optional, loop filtering (for de-blocking and de-artifacting purposes).

With reference back to FIG. 23, a first distortion calculation module (2330) calculates distortion based on a comparison between an output of the previous layer reconstructor (2310), which comprises information from the previous layer, and a first view V₀ (2301). A second distortion calculation module (2332) calculates distortion based on a comparison between the output of the previous layer reconstructor (2310) and the second view V₁ (2302). A first distortion estimate D (2350) is a function of distortion calculations from the first and second distortion calculation modules (2330, 2332).

Similarly, a third and fourth distortion calculation modules (2334, 2336) generate distortion calculations based on the RPU output r_{RPU} (2325) and the first and second views V₀ and V₁ (2301, 2302), respectively. A second distortion estimate D′ (2352) is a function of distortion calculations from the third and fourth distortion calculation modules (2334, 2336).

Calculating the distortion on the full resolution pictures by considering only the previous layer would still not account for the impact on the dependent layers. However, it would be beneficial in applications where the base layer quality in the up-sampled full-resolution domain is important. One such scenario includes broadcast of frame-compatible stereo image pairs without an enhancement layer. While pixel-based metrics such as SSD and PSNR would be unaffected, perceptual metrics could benefit if the previous layer was up-sampled to full resolution prior to quality measurement.

Let D_{BL,FR} denote distortion of full resolution views if the distortion was interpolated/up-sampled to full resolution using samples of the previous layer (the BL for this example) and all of the layers on which it depends. Let D_{EL,FR} denote distortion of full resolution views if the distortion was interpolated/up-sampled to full resolution using the samples of the previous layer and all of the layers to decode dependent layer EL. Multiple dependent layers may be possible. These distortions are calculated with respect to their original full resolution views and not the individual layer input sources. Processing may be optionally applied to the original full resolution views, especially if pre-processing is used to generate the layer input sources.

The distortion calculation modules in the previously described embodiments in each of examples 1-4 may adopt full-resolution distortion metrics through interpolation of the missing samples. The same is true also for the selector modules (1304) in example 4. The selectors (1304) may either consider the full-resolution reconstruction for the given enhancement layer or may jointly consider both the previous layer and the enhancement layer full resolution distortions.

In case of Lagrangian minimization, metrics may be modified as: J=w₀×D_{BL,FR}+w₁×D_{EL,FR}+λ×R. As described in the previous embodiments, the values of the weights for each distortion term may depend on the perceptual as well as monetary or commercial significance of each operation point such as either full-resolution reconstruction using just the previous layer samples or full-resolution reconstruction that considers all layers used to decode the EL enhancement layer. The distortion of each layer may either use high-complexity reconstructed blocks or use the prediction blocks to speed up computations.

In cases with multiple layers, it may be desirable to optimize joint coding decisions for multiple operating points that correspond to different dependent layers. If one layer is denoted as EL1 and a second one as EL2, then the coding decision criteria are modified to also account for both layers. In case of Lagrangian minimization, all operating points can be evaluated with the equation: J=w₀×D_{BL,FR}+w₁×D_{EL1,FR}+w₂×D_{EL2,FR}+λ×R.

In another embodiment, different distortion metrics for each layer can be evaluated. This is possible by properly scaling the metrics so that they can still jointly be used in a selection criterion such as the Lagrangian minimization function. For example, one layer may use the SSD metric and another some combination of the SSIM and SSD metric. One thus can use higher-performing and more costly metrics for layers (or full-resolution view reconstructions at those layers) that are considered to be more important.

Furthermore, a metric without full-resolution evaluation and a metric with full-resolution evaluation can be used for the same layer. This may be desirable, for example, in the frame-compatible side-by-side arrangement if no control or knowledge is available concerning the internal up-sampling to full resolution process of the display. However, full-resolution considerations for the dependent layer may be utilized since in some two-layer systems all samples are available without interpolation. Specifically, both the D and D′ metrics may be used in conjunction with the D_{BL,FR} and D_{EL,FR} metrics. Joint optimization of each of the distortion metrics may be performed.

FIG. 22 shows an implementation of full resolution view evaluation during calculation of the distortion (1901 & 1903) for the dependent (e.g., enhancement) layer such that the full resolution distortion may be derived. The distortion metrics for each view (1907 & 1909) may differ and a distortion combiner (1905) yields the final distortion estimate (1913). The distortion combiner can be linear or a maximum or minimum operation.

Additional embodiments may perform full-resolution reconstruction using also prediction or reconstructed samples from the previous layer or layers and the estimated dependent layer samples that are generated by the RPU processor. Instead of D′ representing the distortion of the dependent layer, the distortion D′ may be calculated by considering the full resolution reconstruction and the full resolution source views. This embodiment also applies to examples 1-4.

Specifically, a reconstructor that provides the full-resolution reconstruction for a target layer (e.g., a dependent layer) may also require additional input from higher priority layers such as a previous layer. In a first example, consider that a base layer codes a frame-compatible representation. A first enhancement layer uses inter-layer prediction from the base layer via an RPU and codes the full-resolution left view. A second enhancement layer uses inter-layer prediction from the base layer via another RPU and codes the full-resolution right view. The reconstructor takes as inputs outputs from each of the two enhancement layers.

In another example, consider that a base layer codes a frame-compatible representation that comprises even columns of the left view and odd columns of the right view. An enhancement layer uses inter-layer prediction from the base layer via an RPU and codes a frame-compatible representation that comprises odd columns of the left view and even columns of the right view. Outputs from each of the base and the enhancement layer are fed into the reconstructor to provide full resolution reconstructions of the views.

It should be noted that the full-resolution reconstruction used to reconstruct the content (e.g., the views) may not be identical to original input views. The full-resolution reconstruction may be of lower resolution or higher resolution compared to samples packed in the frame-compatible base layer or layers.

In summary, according to several embodiments, the present disclosure considers embodiments which can be implemented in products developed for use in scalable full-resolution 3D stereoscopic encoding and generic multi-layered video coding. Applications include BD video encoders, players, and video discs created in the appropriate format, or even content and systems targeted for other applications such as broadcast, satellite, and IPTV systems, etc.

The methods and systems described in the present disclosure may be implemented in hardware, software, firmware or combination thereof. Features described as blocks, modules or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), or a field programmable logic array (FPGA)).

As described herein, an embodiment of the present invention may thus relate to one or more of the example embodiments that are enumerated in Table 1, below. Accordingly, the invention may be embodied in any of the forms described herein, including, but not limited to the following Enumerated Example Embodiments (EEEs) which described structure, features, and functionality of some portions of the present invention.

### Table 1

### Enumerated Example Embodiments

EEE1. A method for optimizing coding decisions in a multi-layer layer frame-compatible image or video delivery system comprising one or more independent layers, and one or more dependent layers, the system providing a frame-compatible representation of multiple data constructions, the system further comprising at least one reference processing unit (RPU) between a first layer and at least one of the one or more dependent layers, the first layer being an independent layer or a dependent layer,

the method comprising:

providing a first layer estimated distortion; and

providing one or more dependent layer estimated distortions.

EEE2. The method of Enumerated Example Embodiment 1, wherein the image or video delivery system provides full-resolution representation of the multiple data constructions.

EEE3. The method of any one of claims 1-2, wherein the RPU is adapted to receive reconstructed region or block information of the first layer.

EEE4. The method of any one of claims 1-2, wherein the RPU is adapted to receive predicted region or block information of the first layer.

EEE5. The method of Enumerated Example Embodiment 3, wherein the reconstructed region or block information input to the RPU is a function of forward and inverse transformation and quantization.

EEE6. The method of any one of the previous claims, wherein the RPU uses pre-defined RPU parameters to predict samples for the dependent layer.

EEE7. The method of Enumerated Example Embodiment 6, wherein the RPU parameters are fixed.

EEE8. The method of Enumerated Example Embodiment 6, wherein the RPU parameters depend on causal past.

EEE9. The method of Enumerated Example Embodiment 6, wherein the RPU parameters are a function of the RPU parameters selected from a previous frame in a same layer.

EEE10. The method of Enumerated Example Embodiment 6, wherein the RPU parameters are a function of the RPU parameters selected for neighboring blocks or regions in a same layer.

EEE11. The method of Enumerated Example Embodiment 6, wherein the RPU parameters are adaptively selected between fixed and those that depend on causal past.

EEE12. The method of any one of claims 1-11, wherein the coding decisions consider luma samples.

EEE13. The method of any one of claims 1-11, wherein the coding decisions consider luma samples and chroma samples.

EEE14. The method of any one of claims 1-13, wherein the one or more dependent layer estimated distortions estimate distortion between an output of the RPU and an input to at least one of the one or more dependent layers.

EEE15. The method of Enumerated Example Embodiment 14, wherein the region or block information from the RPU in the one or more dependent layers is further processed by a series of forward and inverse transformation and quantization operations for consideration for the distortion estimation.

EEE16. The method of Enumerated Example Embodiment 15, wherein the region or block information processed by transformation and quantization are entropy encoded.

EEE17. The method of Enumerated Example Embodiment 16, wherein the entropy encoding is a universal variable length coding.

EEE18. The method of Enumerated Example Embodiment 16, wherein the entropy encoding is a variable length coding method with a lookup table, the lookup table providing an estimate number of bits to use while coding.

EEE19. The method of any one of claims 1-18, wherein the estimated distortion is selected from the group consisting of sum of squared differences, peak signal-to-noise ratio, sum of absolute differences, sum of absolute transformed differences, and structural similarity metric.

EEE20. The method according to any one of the previous claims, wherein the first layer estimated distortion and the one or more dependent layer estimated distortions are jointly considered for joint layer optimization.

EEE21. The method of Enumerated Example Embodiment 20, wherein joint consideration of the first layer estimated distortion and the one or more dependent layer estimated distortions are performed using weight factors in a Lagrangian equation.

EEE22. The method of Enumerated Example Embodiment 21, wherein the sum of the weight factors equals one.

EEE23. The method of any one of claims 21-22, wherein value of a weight factor assigned to a layer is a function of relative importance of that layer with respect to the other.

EEE24. The method according to any one of claims 1-23, further comprising selecting optimized RPU parameters for the RPU for operation of the RPU during consideration of the dependent layer impact on coding decisions for a first layer region.

EEE25. The method according to Enumerated Example Embodiment 24, wherein the optimized RPU parameters are a function of an input to the first layer and an input to the one or more dependent layers.

EEE26. The method of Enumerated Example Embodiment 24 or 25, wherein the optimized RPU parameters are provided as part of a previous first layer mode decision.

EEE27. The method of Enumerated Example Embodiment 24 or 25, wherein the optimized RPU parameters are provided prior to starting coding of a first layer.

EEE28. The method of any one of claims 24-27, wherein the input to the first layer is an encoded input.

EEE29. The method of any one of claims 24-28, wherein the encoded input is quantized.

EEE30. The method of Enumerated Example Embodiment 29, wherein the encoded input is a result of an intra-encoder.

EEE31. The method of any one of claims 24-30, wherein the selected RPU parameters vary on a region basis, and multiple sets may be considered for coding decisions in each region.

EEE32. The method of any one of claims 24-30, wherein the selected RPU parameters vary on a region basis, and a single set is considered for coding decisions in each region.

EEE33. The method of Enumerated Example Embodiment 32, wherein the step of optimizing RPU parameters further comprises:
(a) selecting an RPU parameter set for a current region;
(b) testing coding parameter set using a selected fixed RPU parameter set;
(c) repeating step (b) for every coding parameter set;
(d) selecting one of tested coding parameters by satisfying a pre-determined criterion;
(e) coding the region of the first layer using the selected coding parameter set; and
(f) repeating steps (a)-(e) for every region.

EEE34. The method of Enumerated Example Embodiment 31, wherein the step of providing RPU parameters further comprising:
(a) applying a coding parameter set;
(b) selecting RPU parameters based on the reconstructed or the predicted region that is a result of the coding parameter set of step (a);
(c) providing the RPU parameters to the RPU;
(d) testing coding parameter set using the selected RPU parameter set of step (b);
(e) repeating steps (a)-(d) for every coding parameter set;
(f) selecting one of the tested coding parameters by satisfying a pre-determined criterion; and
(g) repeating steps (a)-(f) for every region.

EEE35. The method of any one of the previous claims, wherein at least one of the one or more dependent layer estimated distortions is a temporal distortion, wherein the temporal distortion is a distortion that considers reconstructed dependent layer pictures from previously coded frames.

EEE36. The method of any one of previous claims, wherein the temporal distortion in the one or more dependent layers is an estimated distortion between an output of a temporal reference and an input to at least one of the one or more dependent layers, wherein the temporal reference is a dependent layer reference picture from dependent layer reference picture buffer.

EEE37. The method of Enumerated Example Embodiment 36, wherein the temporal reference is a function of motion estimation and motion compensation of region or block information from the one or more dependent layer reference picture buffers and causal information.

EEE38. The method of any one of claims 35-37, wherein at least one of the one or more dependent layer estimated distortions is an inter-layer estimated distortion.

EEE39. The method of any one of claims 36-38, further comprising selecting, for each of the one or more dependent layers, an estimated distortion between the inter-layer estimated distortion and temporal distortion.

EEE40. The method of any one of claims 36-39, wherein the inter-layer estimated distortion is a function of disparity estimation and disparity compensation in the one or more dependent layers.

EEE41. The method of any one of claims 35-40, wherein the estimated distortion is a minimum of the inter-layer estimated distortion and the temporal distortion.

EEE42. The method of any one of claims 35-41, wherein the at least one of the one or more dependent layer estimated distortions is based on a corresponding frame from the first layer.

EEE43. The method of Enumerated Example Embodiment 42, wherein the corresponding frame from the first layer provides information for dependent layer distortion estimation comprising at least one of motion vectors, illumination compensation parameters, deblocking parameters, and quantization offsets and matrices.

EEE44. The method of Enumerated Example Embodiment 43, further comprising conducting a refinement search based on the motion vectors.

EEE45. The method of any one of claims 35-44, further comprising an iterative method, the steps comprising:
(a) initializing an RPU parameter set;
(b) encoding first layer by considering the selected RPU parameter;
(c) deriving an RPU processed reference picture;
(d) encoding first layer using the derived RPU reference to consider motion compensation for the RPU processed reference picture; and
(e) repeating steps (b)-(d) until a performance or a maximum iteration criterion is satisfied.

EEE46. The method any one of claims 35-44, further comprising an iterative method, the steps comprising:
(a) selecting an RPU parameter set;
(b) encoding first layer by considering the selected RPU parameter;
(c) deriving a new RPU parameter set and optionally deriving an RPU processed reference picture; and
(d) optionally coding the dependent layer of the current frame;
(e) encoding the first layer using the derived RPU parameter set, and optionally considering the RPU processed reference to model motion compensation for RPU processed reference picture, and optionally considering coding decisions at the dependent layer from step (d); and
(f) repeating steps (c)-(e) until a performance or a maximum iteration criterion is satisfied.

EEE47. The method of any one of claims 35-44, further comprising:
(a) dividing a frame into groups of regions, and wherein a group comprises at least two spatially neighboring regions, initializing an RPU parameter set;
(b) optionally selecting the RPU parameter set;
(c) encoding the group of regions of the first layer by considering the at least one of the one or more dependent layers while considering non-causal areas when available;
(d) selecting an new RPU parameter set;
(e) encoding the group of regions by using the new RPU parameter set while considering non-causal areas when available;
(f) repeating steps (d)-(e) until a performance or a maximum iteration criterion is satisfied; and
(g) repeating steps (c)-(f) until all groups of the regions have been coded.

EEE48. The method of claims 47, wherein the groups overlap.

EEE49. The method of any one of the previous claims, wherein the one or more estimated distortion comprises a combination of one or more distortion calculation.

EEE50. The method of Enumerated Example Embodiment 49, wherein a first one or more distortion calculations is a first data construction and a second one or more distortion calculations is a second data construction.

EEE51. The method of Enumerated Example Embodiment 50, wherein the distortion calculation for the first data construction and the distortion calculation for the second data construction are functions of fully reconstructed samples of the first layer and the one or more dependent layers.

EEE52. The method of any one of claims 49-51, wherein the first layer estimated distortion and the one or more dependent layer estimated distortions are jointly considered for joint layer optimization.

EEE53. The method of Enumerated Example Embodiment 52, wherein the first layer estimated distortion and the one or more dependent layer estimated distortions are both considered.

EEE54. The method of Enumerated Example Embodiment 52, wherein joint optimization of the first layer estimated distortion and the one or more dependent layer estimated distortions are performed using weight factors in a Lagrangian equation.

EEE55. The method of any one of the previous claims, wherein the first layer is a base or enhancement layer, and the one or more dependent layers are respective one or more enhancement layers.

EEE56. A joint layer frame-compatible coding decision optimization system comprising:
a first layer;
a first layer estimated distortion unit;
one or more dependent layers;
at least one reference processing unit (RPU) between the first layer and at least one of the one or more dependent layers; and
one or more dependent layer estimate distortion units between the first layer and at least one of the one or more dependent layers.

EEE57. The system of Enumerated Example Embodiment 56, wherein the at least one of the one or more dependent layer estimated distortion units is adapted to estimate distortion between a reconstructed output of the RPU and an input to at least one of the one or more dependent layers.

EEE58. The system of Enumerated Example Embodiment 56, wherein the at least one of the one or more dependent layer estimated distortion units is adapted to estimate distortion between a predicted output of the RPU and an input to at least one of the one or more dependent layers.

EEE59. The system of Enumerated Example Embodiment 56, wherein the RPU is adapted to receive reconstructed samples of the first layer as input.

EEE60. The system of Enumerated Example Embodiment 58, wherein the RPU is adapted to receive prediction region or block information of the first layer as input.

EEE61. The system of Enumerated Example Embodiment 57 or 58, wherein the RPU is adapted to receive reconstructed samples of the first layer or prediction region or block information of the first layer as input.

EEE62. The system of any one of claims 56-61, wherein the estimated distortion is selected from the group consisting of sum of squared differences, peak signal-to-noise ration, sum of absolute differences, sum of absolute transformed differences, and structural similarity metric.

EEE63. The system according to any one of claims 56-61, wherein an output from the first layer estimated distortion unit and an output from the one or more dependent layer estimated distortion unit are adapted to be jointly considered for joint layer optimization.

EEE64. The system of Enumerated Example Embodiment 56, wherein the dependent layer estimated distortion unit is adapted to estimate distortion between a processed input and an unprocessed input to the one or more dependent layers.

EEE65. The system of Enumerated Example Embodiment 64, wherein the processed input is a reconstructed sample of the one or more dependent layers.

EEE66. The system of Enumerated Example Embodiment 64 or 65, wherein the processed input is a function of forward and inverse transform and quantization.

EEE67. The system of any one of claims 56-66, wherein an output from the first layer estimated distortion unit, and the one or more dependent layer estimated distortion units are jointly considered for joint layer optimization.

EEE68. The system according to any one of claims 56-67, further comprising a parameter optimization unit adapted to provide optimized parameters to the RPU for operation of the RPU.

EEE69. The system according to Enumerated Example Embodiment 68, wherein the optimized parameters are a function of an input to the first layer and an input to the one or more dependent layers.

EEE70. The system of Enumerated Example Embodiment 69, further comprising an encoder, the encoder adapted to encode the input to the first layer and provide the encoded input to the parameter optimization unit.

EEE71. The system of Enumerated Example Embodiment 56, wherein the dependent layer estimated distortion unit is adapted to estimate inter-layer distortion and/or temporal distortion.

EEE72. The system of Enumerated Example Embodiment 56, further comprising a selector, the selector adapted to select, for each of the one or more dependent layers, between an inter-layer estimated distortion and a temporal distortion.

EEE73. The system of Enumerated Example Embodiment 71 or 72, wherein an inter-layer estimate distortion unit is directly or indirectly connected to a disparity estimation unit and a disparity compensation unit, and a temporal estimated distortion unit is directly or indirectly connected to a motion estimation unit and a motion compensation unit in the one or more dependent layers.

EEE74. The system of Enumerated Example Embodiment 72, wherein the selector is adapted to select the smaller of the inter-layer estimated distortion and the temporal distortion.

EEE75. The system of Enumerated Example Embodiment 71, wherein the dependent layer estimated distortion unit is adapted to estimate the inter-layer distortion and/or the temporal distortion is based on a corresponding frame from a previous layer.

EEE76. The system of Enumerated Example Embodiment 75, wherein the corresponding frame from the previous layer provides information comprising at least one of motion vectors, illumination compensation parameters, deblocking parameters, and quantization offsets and matrices.

EEE77. The system of Enumerated Example Embodiment 76, further comprising conducting a refinement search based on the motion vectors.

EEE78. The system of Enumerated Example Embodiment 56, further comprising a distortion combiner adapted to combine an estimate from a first data construction estimated distortion unit and an estimate from a second data construction estimated distortion unit to provide the inter-layer estimated distortion.

EEE79. The system of Enumerated Example Embodiment 78, wherein the first data construction distortion calculation unit and the second data construction distortion calculation unit are adapted to estimate fully reconstructed samples of the first and the one or more dependent layers.

EEE80. The system of any one of claims 56-79, wherein an output from the first layer estimated distortion unit, and the dependent layer estimated distortion unit are jointly considered for joint layer optimization.

EEE81. The system of Enumerated Example Embodiment 56, wherein the first layer is a base layer or an enhancement layer, and the one or more dependent layers are respective one or more enhancement layers.

EEE82. The method of any one of claims 1-55, the method further comprising providing an estimated rate distortion.

EEE83. The method of any one of claims 1-55 and 82, the method further comprising providing an estimate of complexity.

EEE84. The method of Enumerated Example Embodiment 83, wherein the estimate of complexity is based on at least one of implementation, computation and memory complexity.

EEE85. The method of any one of claim 83 or 84, wherein the estimated rate distortion and/or complexity are taken into account as additional lambda parameters.

EEE86. An encoder for encoding a video signal according to the method recited in any one of claim 1-55 or 82-85.

EEE87. An encoder for encoding a video signal, the encoder comprising the system recited in any one of claims 56-81.

EEE88. An apparatus for encoding a video signal according to the method recited in any one of claim 1-55 or 82-85.

EEE89. An apparatus for encoding a video signal, the apparatus comprising the system recited in any one of claims 56-81.

EEE90. A system for encoding a video signal according to the method recited in any one of claim 1-55 or 82-85.

EEE91. A computer-readable medium containing a set of instructions that causes a computer to perform the method recited in any one of claim 1-55 or 82-85.

EEE92. Use of the method recited in any one of claim 1-55 or 82-85 to encode a video signal.

Furthermore, all patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

The examples set forth above are provided to give those of ordinary skill in the art a complete disclosure and description of how to make and use the embodiments of joint layer optimization for frame-compatible video delivery of the disclosure, and are not intended to limit the scope of what the inventors regard as their disclosure. Modifications of the above-described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a”, “an”, and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

### LIST OF REFERENCES

[1] D. C. Hutchison, “Introducing DLP 3-D TV”, http://www.dlp.com/downloads/Introducing DLP 3D HDTV Whitepaper.pdf
[2] Advanced video coding for generic audiovisual services, http://www.itu.int/rec/recommendation.asp?type=folders&lang=e&parent=T-REC-H.264, March 2010.
[3] SMPTE 421M, “VC-1 Compressed Video Bitstream Format and Decoding Process”, April 2006.
[4] G. J. Sullivan and T. Wiegand, “Rate-Distortion Optimization for Video Compression”, IEEE Signal Processing Magazine, pp. 74-90, November 1998.
[5] A. Ortega and K. Ramchandran, “Rate-Distortion Methods for Image and Video Compression”, IEEE Signal Processing Magazine, pp. 23-50, November 1998.
[6] H. Schwarz and T. Wiegand, “R-D optimized multi-layer encoder control for SVC,” Proceedings IEEE Int. Conf. on Image Proc., San Antonio, Tex., September 2007.
[7] Z. Yang, F. Wu, and S. Li, “Rate distortion optimized mode decision in the scalable video coding”, Proc. IEEE International Conference on Image Processing (ICIP), vol. 3, pp. 781-784, Spain, September 2003.
[8] D. T. Hoang, P. M. Long, and J. Vitter, “Rate-Distortion Optimizations for Motion Estimation in Low-Bitrate Video Coding”, IEEE Transactions on Circuits and Systems for Video Technology, vol. 8, no. 4, August 1998, pp. 488-500.

1. A method for optimizing coding decisions in a multi-layer layer frame-compatible image or video delivery system comprising one or more independent layers, and one or more dependent layers, the system providing a frame-compatible representation of multiple data constructions, the system further comprising at least one reference processing unit (RPU) between a first layer and at least one of the one or more dependent layers, the first layer being an independent layer or a dependent layer,
the method comprising:
providing a first layer estimated distortion; and
providing one or more dependent layer estimated distortions.

2. The method of claim 1, wherein the image or video delivery system provides full-resolution representation of the multiple data constructions.

3. The method of claim 1, wherein the RPU is adapted to receive reconstructed region or block information of the first layer.

4. The method of claim 1, wherein the RPU is adapted to receive predicted region or block information of the first layer.

5. The method of claim 3, wherein the reconstructed region or block information input to the RPU is a function of forward and inverse transformation and quantization.

6. The method of claim 1, wherein the RPU uses pre-defined RPU parameters to predict samples for the dependent layer.

7. The method of claim 6, wherein the RPU parameters are fixed.

8. The method of claim 6, wherein the RPU parameters depend on causal past.

9. The method of claim 6, wherein the RPU parameters are a function of the RPU parameters selected from a previous frame in a same layer.

10. The method of claim 6, wherein the RPU parameters are a function of the RPU parameters selected for neighboring blocks or regions in a same layer.

11. The method of claim 6, wherein the RPU parameters are adaptively selected between fixed and those that depend on causal past.

12. The method of claim 1, wherein the coding decisions consider luma samples.

13. The method of claim 1, wherein the coding decisions consider luma samples and chroma samples.

14. The method of claim 1, wherein the one or more dependent layer estimated distortions estimate distortion between an output of the RPU and an input to at least one of the one or more dependent layers.

15. The method of claim 14, wherein the region or block information from the RPU in the one or more dependent layers is further processed by a series of forward and inverse transformation and quantization operations for consideration for the distortion estimation.

16. The method of claim 15, wherein the region or block information processed by transformation and quantization are entropy encoded.

17. A joint layer frame-compatible coding decision optimization system comprising:
a first layer;
a first layer estimated distortion unit;
one or more dependent layers;
at least one reference processing unit (RPU) between the first layer and at least
one of the one or more dependent layers; and
one or more dependent layer estimate distortion units between the first layer and at least one of the one or more dependent layers.

18. A system, comprising means for performing the method as recited in claim 1.

19. A computer readable storage medium comprising instructions, which when executed with a processor, cause, control, program or configure the processor to perform a method as recited in claim 1.

20. An apparatus, comprising:
a processor; and
a computer readable storage medium comprising instructions, which when executed with a processor, cause, control, program or configure the processor to perform a method as recited in claim 1.
